(19) United States
(12) Patent Application Publication
(10) Pub. No.: US 2018/0095192 A1
(43) Pub. Date: Apr. 5, 2018

(54) ANTIREFLECTION FILM, OPTICAL ELEMENT, AND OPTICAL SYSTEM

(71) Applicant: FUJIFILM Corporation, Tokyo (JP)

(72) Inventors: Shinichiro Sonoda, Kanagawa (JP); Hideki Yasuda, Kanagawa (JP); Akihiko Ohtsu, Kanagawa (JP)

(73) Assignee: FUJIFILM Corporation, Tokyo (JP)

(21) Appl. No.: 15/821,143

(22) Filed: Nov. 22, 2017

Related U.S. Application Data
(63) Continuation of application No. PCT/JP2016/002488, filed on May 23, 2016.

(30) Foreign Application Priority Data
May 28, 2015 (JP) 2015-108398
Aug. 28, 2015 (JP) 2015-168939

(51) Int. Cl. G02B 1/116; B32B 7/02; B32B 15/04; G02B 15/20; G02B 15/163

(52) U.S. Cl. CPC G02B 1/116; B32B 7/02; B32B 15/04; B32B 2309/105; G02B 15/163; B32B 2307/418; G02B 15/20

(57) ABSTRACT

This antireflection film includes a dielectric layer having a surface exposed to air and having a refractive index of 1.35 or more and 1.51 or less, a metal layer having an interface with the dielectric layer, containing silver, and having a thickness of 5 nm or less, and an interlayer having an interface with the metal layer and constituted by a laminate formed by alternately laminating total four layers or more of a layer of high refractive index having a relatively high refractive index and a layer of low refractive index having a relatively low refractive index and is laminated on a substrate having a refractive index of 1.61 or more in the order of the interlayer, the metal layer, and the dielectric layer.

### CROSS REFERENCE TO RELATED APPLICATIONS

The present application is a Continuation of PCT International Application No. PCT/JP2016/002488 filed on May 23, 2016, which claims priority under 35 U.S.C. § 119(a) to Japanese Patent Application No. 2015-108398 filed on May 28, 2015 and Japanese Patent Application No. 2015-168939 filed on Aug. 28, 2015. Each of the above applications is hereby expressly incorporated by reference, in its entirety, into the present application.

### BACKGROUND OF THE INVENTION

### 1. Field of the Invention

The present invention relates to an antireflection film, an optical element including an antireflection film, and an optical system including the optical element.

### 2. Description of the Related Art

In the related art, in a lens (transparent substrate) formed of a light transmitting member such as glass or a plastic, an antireflection film is provided on a light incident surface in order to reduce the loss of transmitted light caused by surface reflection.

As an antireflection film that exhibits a very low reflectance with respect to visible light, configurations of a fine uneven structure having a pitch shorter than the wavelength of visible light and a porous structure obtained by forming a large number of pores on the uppermost layer thereof are known (refer to JP2012-159720A, JP2005-316386A, and the like).

In a case of using an antireflection film having a structure layer of a fine uneven structure, a porous structure, or the like on the uppermost layer as a layer of low refractive index, an ultra-low reflectance of 0.2% or less can be obtained in a wide wavelength range of a visible light region. However, since these films have a fine structure on the surface thereof, there are defects that the film has low mechanical strength and is very weak to an external force such as wiping. Therefore, portions such as outermost surfaces (first lens front surface and final lens back surface) of a group lens used for a camera lens or the like, which are touched by a user, cannot be subjected to ultra-low reflectance coating having a structure layer.

On the other hand, as an antireflection film not including a structure layer on the surface thereof, an antireflection film including a metal layer containing silver (Ag) in a laminate of a dielectric film is proposed in JP2013-238709A, JP4560889B, or the like.

JP2013-238709A discloses an optical laminate that includes a dielectric layer having a surface exposed to air, a metal layer having an interface with the dielectric layer and containing at least Ag, and a laminate having an interface with the metal layer and including one or more layers of low refractive index and one or more layers of high refractive index, in which a reflectance in a wavelength range of 460 nm or more and 650 nm or less is 0.1% or less.

In addition, in JP4560889B, an antireflection film constituted by a laminate formed by laminating a transparent film having a relatively high refractive index, a film containing silver, and a transparent film having a relatively low refractive index from a substrate side, in which the reflectance of the film surface with respect to an incidence ray at 550 nm is 0.6% or less is proposed.

### SUMMARY OF THE INVENTION

However, in JP2013-238709A, the refractive index of the substrate forming the antireflection film is not mentioned at all. On the other hand, in JP4560889B, a reflectance of 0.2% or less is realized by providing the antireflection film on the substrate formed of soda lime glass.

The present inventors conducted an investigation on a case in which the antireflection film having the layer configuration described in the example of JP2013-238709A is provided on the substrate of each refractive index by changing the refractive index of the substrate forming the optical laminate disclosed in JP2013-238709A from 1.49 to 1.61 at an interval of 0.01. The layer configuration from the substrate to the layer exposed to air, which is a medium, was set as shown in Table 1. The optimization of film thickness and calculation of wavelength dependence of reflectance (reflection spectrum) were performed using Essential Macleod (developed by Thin Film Center Inc.). Here, regarding the refractive index of Ag, the refractive index (denoted as Ag (1) in the table) shown in “Handbook of Optical Constants of Solids. 1985, Academic Press Inc. p. 353” (hereinafter, referred to as “Reference Document 1”) was used.

TABLE 1

| | Constitutional | Refractive | Physical film |
|---|---|---|---|
| Layer | material | index | thickness (nm) |
| Medium | Air | 1 | — |
| Dielectric film | SiO₂ | 1.479 | 77.74 |
| Metal layer | Ag (1) | 0.13 | 6.5 |
| Interlayer 1 | TiO₂ | 2.291 | 22.13 |
| Interlayer 2 | SiO₂ | 1.479 | 171.53 |
| Substrate | 1.49 to 1.61 | 1.49 to 1.61 | — |

Each reflection spectrum at each refractive index n=1.49 to 1.61 is shown in FIG. 18.

As shown in FIG. 18, in a case in which the refractive index of the substrate is in a range of 1.51 to 1.55, the reflectance in a wavelength range of 450 nm or more and 650 nm or less is 0.1% or less. On the other hand, in a case in which the refractive index of the substrate is 1.6, it was found that the maximum reflectance in a wavelength range of 450 nm or more and 650 nm or less is 0.2%, and the maximum reflectance at a refractive index of 1.61 is more than 0.2%. From these findings, the refractive index of the substrate defined in JP2013-238709A is considered to be about 1.51 to 1.55. In the investigation of the present inventors, in the structure of the optical laminate disclosed in JP2013-238709A, a reflectance of 0.2% or less is satisfied over the entire wavelength range of 450 nm or more and 650 nm or less in the case in which the refractive index of the substrate is 1.60 or less, and a reflectance of less than 0.2% is not satisfied over the entire wavelength range of 450 nm or more and 650 nm or less in a case in which the refractive index is 1.61 or more.

Similarly, in JP4560889B, in a case in which the antireflection film having the structure described in JP4560889B is provided on a substrate having a higher refractive index, for example, a substrate having a refractive index of 1.59, instead of using the soda lime glass having a refractive index of 1.51, the reflectance is remarkably increased and thus an ultra-low reflectance of 0.2% or less cannot be obtained.

On the other hand, since the first lens of a camera generally requires a high power, a high refractive index glass material having a refractive index of 1.61 or more is used in many cases. For an antireflection film, performance satisfying a reflectance of 0.2% or less over the entire wavelength range of 450 nm or more and 650 nm or less on the surface of such a substrate having a high refractive index is demanded.

The present invention is made in consideration of the above circumstances, and an object thereof is to provide an antireflection film satisfying a reflectance of 0.2% or less over the entire wavelength range of 450 nm or more and 650 nm or less and having high mechanical strength, an optical element including an antireflection film, and an optical system having the optical element.

According to the present invention, there is provided a first antireflection film comprising:

a dielectric layer having a surface exposed to air and having a refractive index of 1.35 or more and 1.51 or less;

a metal layer having an interface with the dielectric layer, containing silver (Ag), and having a thickness of 5 nm or less; and

an interlayer having an interface with the metal layer and constituted by a laminate formed by alternately laminating total four layers or more of a layer of high refractive index having a relatively high refractive index and a layer of low refractive index having a relatively low refractive index,

in which the antireflection film is laminated on a substrate having a refractive index of 1.61 or more in the order of the interlayer, the metal layer, and the dielectric layer.

In the specification, the refractive index is a refractive index with respect to light at a wavelength of 500 nm.

Here, the expression “containing silver” means that the metal layer contains 85% by atom or more of silver.

In the first antireflection film according to the present invention, it is preferable that the dielectric layer is formed of silicon oxide (SiO₂) or magnesium fluoride (MgF₂).

According to the present invention, there is provided a second antireflection film comprising:

a dielectric layer having a surface exposed to air and formed of MgF₂;

a metal layer having an interface with the dielectric layer, containing Ag, and having a thickness of 5 nm or less; and

an interlayer having an interface with the metal layer and constituted by a laminate formed by alternately laminating total three layers or more of a layer of high refractive index having a relatively high refractive index and a layer of low refractive index having a relatively low refractive index,

in which the antireflection film is laminated on a substrate having a refractive index of 1.61 or more and 1.74 or less in the order of the interlayer, the metal layer, and the dielectric layer.

According to the present invention, there is provided a third antireflection film comprising:

a dielectric layer having a surface exposed to air and formed of MgF₂;

a metal layer having an interface with the dielectric layer, containing Ag, and having a thickness of 5 nm or less; and

an interlayer having an interface with the metal layer and constituted by a laminate formed by alternately laminating total two layers or more of a layer of high refractive index having a relatively high refractive index and a layer of low refractive index having a relatively low refractive index,

in which the antireflection film is laminated on a substrate having a refractive index of 1.61 or more and 1.66 or less in the order of the interlayer, the metal layer, and the dielectric layer.

Here, the expressions “having a relatively high refractive index” and “having a relatively low refractive index” refer to a relationship between a layer of high refractive index and a layer of low refractive index and mean that a layer of high refractive index has a higher refractive index than a layer of low refractive index, that is, a layer of low refractive index has a lower refractive index than a layer of high refractive index.

In each of the first to third antireflection films according to the present invention, it is preferable that the layer of high refractive index is a layer having a higher refractive index than the refractive index of the substrate, and the layer of low refractive index is a layer having a lower refractive index than the refractive index of the substrate.

In each of the first to third antireflection films according to the present invention, the laminate constituting the interlayer preferably has 16 layers or less. The laminate constituting the interlayer more preferably has 8 layers or less.

In each of the first to third antireflection films according to the present invention, it is preferable that the metal layer is formed of a silver alloy containing at least one metal element in addition to silver.

In each of the first to third antireflection films according to the present invention, it is preferable that an anchor layer formed of a metal element other than silver is provided between the metal layer and the interlayer.

According to the present invention, there is provided an optical element comprising: a substrate; and the antireflection film according to the present invention arranged on the substrate.

According to the present invention, there is provided an optical system comprising: a group lens formed by arranging the antireflection film of the optical element according to the present invention on outermost surfaces thereof.

Here, the term “outermost surfaces” refer to one side surfaces of lenses arranged at both ends of the group lens constituted by a plurality of lenses and refer to surfaces which become both end surfaces of the group lens.

According to the configuration of the first antireflection film of the present invention, even in a case in which the antireflection film is laminated on the substrate having a refractive index of 1.61 or more, it is possible to realize a reflectance of 0.2% or less with respect to light in a wavelength range of at least 450 nm or more and 650 nm or less.

According to the configuration of the second antireflection film of the present invention, even in a case in which the antireflection film is laminated on the substrate having a refractive index of 1.61 or more and 1.74 or less, it is possible to realize a reflectance of 0.2% or less with respect to light in a wavelength range of at least 450 nm or more and 650 nm or less.

According to the configuration of the third antireflection film of the present invention, even in a case in which the antireflection film is laminated on the substrate having a refractive index of 1.61 or more and 1.66 or less, it is possible to realize a reflectance of 0.2% or less with respect to light in a wavelength range of at least 450 nm or more and 650 nm or less.

The term “reflectance” as used throughout the specification refers a reflectance in a case in which light enters the surface of the antireflection film vertically (at a light incidence angle of 0°).

Since all of the antireflection films according to the present invention have an uneven structure and a porous structure, the mechanical strength is high and the films can be applied to the surface of an optical member which is touched by a hand of a user. In addition, since the uneven structure and the porous structure have fluctuations in the refractive index, scattering occurs. However, since the antireflection films according to the present invention have almost no fluctuations in the refractive index, scattering rarely occurs. Scattering in a camera lens causes the occurrence of flare and thus a contrast in an image is lowered. Thus, less scattering is a great advantage.

### BRIEF DESCRIPTION OF THE DRAWINGS

FIG. 1A is a schematic cross-sectional view showing a schematic configuration of an optical element including an antireflection film according to a first embodiment of the present invention.

FIG. 1B is a schematic cross-sectional view showing a design modification example of the antireflection film according to the first embodiment.

FIG. 2A is a schematic cross-sectional view showing a schematic configuration of an optical element including an antireflection film according to a second embodiment of the present invention.

FIG. 2B is a schematic cross-sectional view showing a design modification example of the antireflection film according to the second embodiment.

FIG. 3A is a schematic cross-sectional view showing a schematic configuration of an optical element including an antireflection film according to a third embodiment of the present invention.

FIG. 3B is a schematic cross-sectional view showing a design modification example of the antireflection film according to the third embodiment.

FIG. 4 is a view showing the configuration of an optical system constituted by a group lens including the optical element according to the present invention.

FIG. 5 is a diagram showing the wavelength dependence of the reflectance of an antireflection film of Example 1.

FIG. 6 is a diagram showing the wavelength dependence of the reflectance of an antireflection film of Example 2.

FIG. 7 is a diagram showing the wavelength dependence of the reflectance of an antireflection film of Example 3.

FIG. 8 is a diagram showing the wavelength dependence of the reflectance of an antireflection film of Example 4.

FIG. 9 is a diagram showing the wavelength dependence of the reflectance of an antireflection film of Example 5.

FIG. 10 is a diagram showing the wavelength dependence of the reflectance of an antireflection film of Example 6.

FIG. 11 is a diagram showing the wavelength dependence of the reflectance of an antireflection film of Example 7.

FIG. 12 is a diagram showing the wavelength dependence of the reflectance of an antireflection film of Example 8.

FIG. 13 is a diagram showing the wavelength dependence of the reflectance of an antireflection film of Example 9.

FIG. 14 is a diagram showing the wavelength dependence of the reflectance of an antireflection film of Example 10.

FIG. 15 is a diagram showing the wavelength dependence of the reflectance of an antireflection film of Example 11.

FIG. 16 is a diagram showing the wavelength dependence of the reflectance of an antireflection film of Example 12.

FIG. 17 is a diagram showing the wavelength dependence of the reflectance of an antireflection film of Example 13.

FIG. 18 is a diagram showing the wavelength dependence of the reflectance of an antireflection film of Comparative Example 1.

FIG. 19 is a diagram showing the wavelength dependence of the reflectance of an antireflection film of Comparative Example 2.

FIG. 20 is a diagram showing the wavelength dependence of the reflectance of an antireflection film of Comparative Example 3.

FIG. 21 is a diagram showing the wavelength dependence of the reflectance of an antireflection film of Comparative Example 4.

FIG. 22 is a diagram showing the wavelength dependence of the reflectance of an antireflection film of Comparative Example 5.

FIG. 23 is a diagram showing the wavelength dependence of the reflectance of an antireflection film of Comparative Example 6.

FIG. 24 is a diagram in which Examples and Comparative Examples in which a dielectric layer is formed of MgF₂ are mapped with the refractive index of a substrate and the number of laminated interlayers.

FIG. 25 is a diagram in which Examples and Comparative Examples in which a dielectric layer is formed of SiO₂ are mapped with the refractive index of a substrate and the number of laminated interlayers.

FIG. 26 is a diagram showing the reflection spectra of a silver film of Preparation Example 1 and a silver alloy film of Preparation Example 2 and the reflection spectrum of a silver film obtained by simulation.

FIG. 27A is an image of the silver film of Preparation Example 1 obtained with a scanning electron microscope.

FIG. 27B is an image of the silver film of Preparation Example 1 obtained with an atomic force microscope.

FIG. 28A is an image of the silver alloy film of Preparation Example 2 obtained with a scanning electron microscope.

FIG. 28B is an image of the silver alloy film of Preparation Example 2 obtained with an atomic force microscope.

### DESCRIPTION OF THE PREFERRED EMBODIMENTS

Hereinafter, embodiments of the present invention will be described.

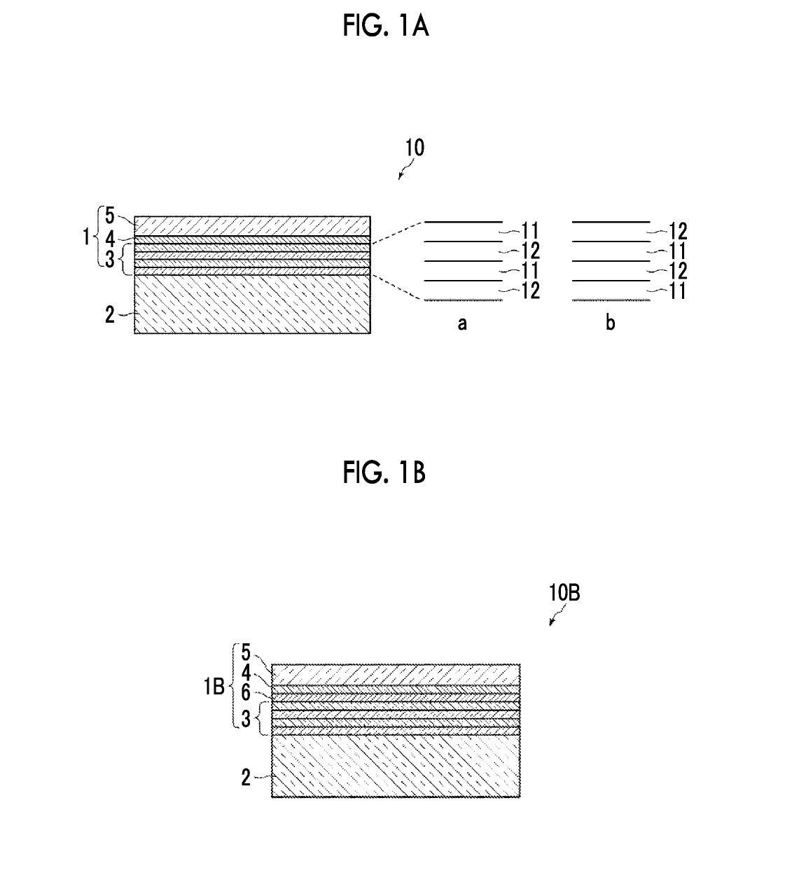

FIG. 1A is a schematic cross-sectional view showing a schematic configuration of an optical element 10 including an antireflection film 1 according to a first embodiment of the present invention. As shown in FIG. 1A, the antireflection film 1 of the embodiment has a dielectric layer 5 having a surface exposed to air and having a refractive index of 1.35 or more and 1.51 or less, a metal layer 4 having an interface with the dielectric layer 5, containing Ag, and having a thickness of 5 nm or less, and an interlayer 3 having an interface with the metal layer 4 and constituted by a laminate formed by alternately laminating total four layers or more of a layer 11 of high refractive index having a relatively high refractive index and a layer 12 of low refractive index having a relatively low refractive index. The antireflection film is laminated on a substrate 2 having a refractive index of 1.61 or more in the order of the interlayer 3, the metal layer 4, and the dielectric layer 5. The optical element 10 includes the substrate 2 having a refractive index of 1.61 or more and the antireflection film 1 formed on the surface of the substrate.

Light to be reflected in the present invention varies depending on the purpose and is generally light in a visible light region. As required, light in an infrared region may be used. In the embodiment, light in a visible light region is mainly targeted. By the configuration of the embodiment, a reflectance of 0.2% or less can be achieved with respect to light in a wavelength range of at least 450 nm to 650 nm.

The shape of the substrate 2 is not particularly limited and the substrate is a transparent optical member that is mainly used in an optical device such as a flat plate, a concave lens, or a convex lens and also may be a substrate constituted by a combination of a curved surface having a positive or negative curvature and a flat surface. As the material for the substrate 2, glass, plastic, and the like can be used. Here, the term “transparent” means being transparent (having an internal transmittance of about 10% or more) to a wavelength of light of which reflection is to be suppressed (reflection prevention target light) in the optical member.

The refractive index of the substrate 2 may be 1.61 or more and is preferably 1.74 or more, and more preferably 1.84 or more. For example, the substrate 2 may be a high power lens such as a first lens of a group lens of a camera or the like.

The interlayer 3 may be formed by alternately laminating the layer 11 of high refractive index and the layer 12 of low refractive index, and as shown in a of FIG. 1A, the layer 12 of low refractive index and the layer 11 of high refractive index may be laminated in this order from the substrate 2. As shown in b of FIG. 1A, the layer 11 of high refractive index and the layer 12 of low refractive index may be laminated in this order from the substrate 2. In addition, the interlayer 3 may have four layers or more but it is preferable to set the number of layers to 16 or less from the viewpoint of suppressing costs.

The refractive index of the layer 11 of high refractive index may be higher than the refractive index of the layer 12 of low refractive index, and the refractive index of the layer 12 of low refractive index may be lower than the refractive index of the layer 11 of high refractive index. It is more preferable that the refractive index of the layer 11 of high refractive index is higher than the refractive index of the substrate 2 and the refractive index of the layer 12 of low refractive index is lower than the refractive index of the substrate 2.

The layers 11 of high refractive index, or the layers 12 of low refractive index may not have the same refractive index. However, it is preferable that the layers are formed of the same material and have the same refractive index from the viewpoint of suppressing material costs, film formation costs, and the like.

Examples of the material for forming the layer 12 of low refractive index include silicon oxide (SiO₂), silicon oxynitride (SiON), gallium oxide (Ga₂O₃), aluminum oxide (Al₂O₃), lanthanum oxide (La₂O₃), lanthanum fluoride (LaF₃), magnesium fluoride (MgF₂), and sodium aluminum fluoride (Na₃AlF₆).

Examples of the material for forming the layer 11 of high refractive index include niobium pentoxide (Nb₂O₅), titanium oxide (TiO₂), zirconium oxide (ZrO₂), tantalum pentoxide (Ta₂O₅), silicon oxynitride (SiON), silicon nitride (Si₃N₄), and silicon niobium oxide (SiNbO).

The refractive index can be changed to some extent by controlling any of these compounds to have the constitutional element ratio which is shifted from the compositional ratio of the stoichiometric ratio or by forming a film by controlling the film formation density.

Each layer of the interlayer 3 is preferably formed by using a vapor phase film formation method such as vacuum deposition, plasma sputtering, electron cyclotron sputtering, or ion plating. According to the vapor phase film formation method, a laminated structure having various refractive indexes and layer thicknesses can be easily formed.

The metal layer 4 is formed of 85% by atom or more of silver with respect to the constitutional elements. The metal layer preferably includes at least one of palladium (Pd), copper (Cu), gold (Au), neodymium (Nd), samarium (Sm), bismuth (Bi) or platinum (Pt), in addition to silver. Specifically, for example, as the material for forming the metal layer 4, an Ag—Nd—Cu alloy, an Ag—Pd—Cu alloy, an Ag—Bi—Nd alloy or the like suitably used. A thin film formed by using pure silver grows into a granular form in some cases and by forming a film containing about several % of Nd, Cu, Bi and/or Pd in Ag, a thin film having higher smoothness is easily formed. The content of the metal element in the metal layer 4 in addition to silver may be less than 15% by atom and is preferably 5% or less and more preferably 2% or less. In this case, the content refers a total content of two or more metal elements in a case in which the metal layer contains two or more metal elements in addition to silver.

The film thickness of the metal layer 4 may be 5 nm or less and is more preferably 2.0 nm or more. The film thickness thereof is even more preferably 2.5 nm or more and particularly preferably 3 nm or less.

In the formation of the metal layer 4 containing Ag, a vapor phase film formation method such as vacuum deposition, plasma sputtering, electron cyclotron sputtering, or ion plating is preferably used.

The material for forming the dielectric layer 5 is not particularly limited as long as the refractive index of the dielectric layer is 1.35 or more and 1.51 or less. Examples thereof include silicon oxide (SiO₂), silicon oxynitride (SiON), magnesium fluoride (MgF₂), and sodium aluminum fluoride (Na₃AlF₆). Particularly preferable is SiO₂ or MgF₂. The refractive index can be changed to some extent by controlling any of these compounds to have the constitutional element ratio which is shifted from the compositional ratio of the stoichiometric ratio or by forming a film by controlling the film formation density.

The thickness of the dielectric layer 5 is preferably about λ/4n in a case in which a target wavelength is λ and the refractive index of the dielectric layer is n. Specifically, the thickness of the dielectric layer is about 70 nm to 100 nm.

FIG. 1B is a cross-sectional view showing a design modification example of the antireflection film 1 according to the first embodiment.

An antireflection film 1B of an optical element 10B shown in FIG. 1B includes an anchor layer 6 between the interlayer 3 and the metal layer 4 containing Ag in the antireflection film 1. As described above, the thin film formed by using pure silver is not a smooth film and grows into a granular form in some cases. After the anchor layer is formed, a film containing silver is formed on the anchor layer so that a thin film having high smoothness can be formed by suppressing granulation. As described above, the metal layer containing a metal element in addition to silver has higher smoothness than the film formed by using pure silver and higher smoothness can be obtained by forming such a metal layer on the anchor layer. As the anchor layer, the metal layer containing a metal element other than silver is preferably used. Specifically, as the material for forming the anchor layer, germanium, titanium, chromium, niobium, molybdenum and the like are suitably used. The thickness of the anchor layer is not particularly limited and is particularly preferably 0.2 nm to 2 nm. In a case in which the thickness is 0.2 nm or more, the granulation of the metal layer to be formed on the anchor layer can be sufficiently suppressed. In a case in which the thickness is 2 nm or less, the absorption of incidence ray by the anchor layer itself can be suppressed and thus the transmittance of the antireflection film can be prevented from being lowered.

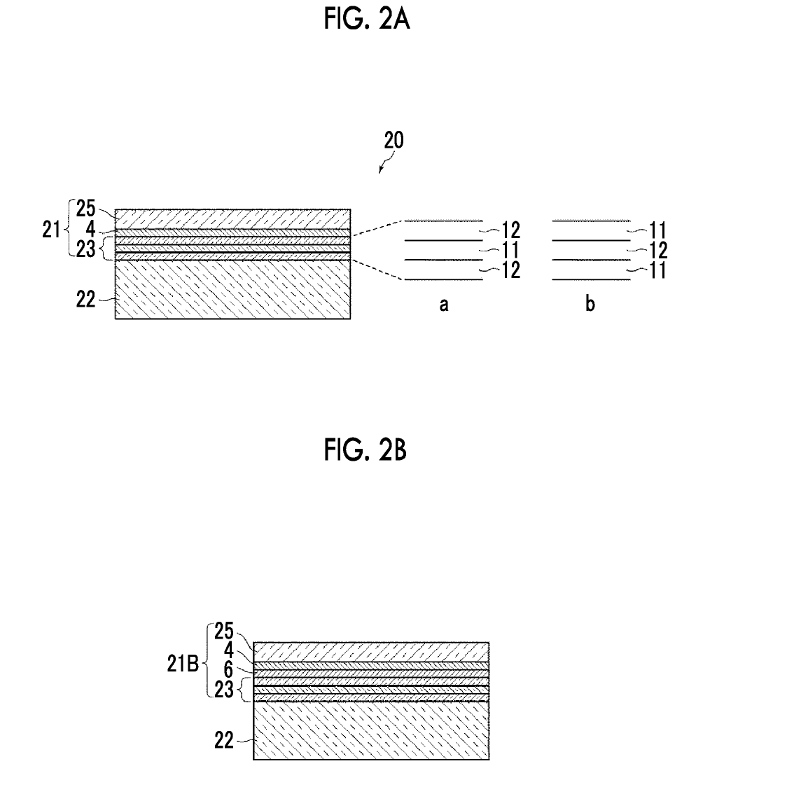

FIG. 2A is a schematic cross-sectional view showing a schematic configuration of an optical element 20 including an antireflection film 21 according to a second embodiment of the present invention. The same reference numerals are assigned to the same elements of the first embodiment shown in FIG. 1A and the detailed descriptions thereof will be omitted. The same is applied to the following drawings.

As shown in FIG. 2A, the antireflection film 21 of the embodiment has a dielectric layer 25 having a surface to be exposed to air and formed of MgF₂, a metal layer 4 having an interface with the dielectric layer 25, containing Ag, and having a thickness of 5 nm or less, and an interlayer 23 having an interface with the metal layer 4 and constituted by a laminate formed by alternately laminating total three layers or more of a layer 11 of high refractive index having a relatively high refractive index and a layer 12 of low refractive index having a relatively low refractive index, and is laminated on a substrate 22 having a refractive index of 1.61 or more and 1.74 or less in the order of the interlayer 23, the metal layer 4, and the dielectric layer 25. The optical element 20 includes the substrate 22 having a refractive index of 1.61 or more and 1.74 or less and the antireflection film 21 formed on the surface of the substrate.

The antireflection film 21 of the embodiment is different from the antireflection film 1 of the first embodiment. Although the material of the dielectric layer 25 is limited to MgF₂, the interlayer 23 may have a three-layer structure. However, the refractive index of the substrate 22 on which the antireflection film 21 of the embodiment is formed is set to 1.74 or less.

The interlayer 23 may be formed by alternately laminating the layer 11 of high refractive index and the layer 12 of low refractive index, and as shown in a of FIG. 2A, the layer 12 of low refractive index and the layer 11 of high refractive index may be laminated in this order from the substrate 22. As shown in b of FIG. 2A, the layer 11 of high refractive index and the layer 12 of low refractive index may be laminated in this order from the substrate 22. In addition, the interlayer 23 may have three layers or more but it is preferable to set the number of layers to 16 or less from the viewpoint of suppressing costs.

By providing the antireflection film 21 of the embodiment arranged on the substrate 22 having a refractive index of 1.61 or more and 1.74 or less, a reflectance of 0.2% or less can be achieved with respect to light in a wavelength range of at least 450 nm to 650 nm.

It is preferable that the antireflection film 21 according to the second embodiment is also modified to an antireflection film 21B having a structure in which an anchor layer 6 between the interlayer 23 and the metal layer 4 containing Ag as shown in the design modification example in FIG. 2B. The details of the anchor layer are as described in the design modification example of the first embodiment.

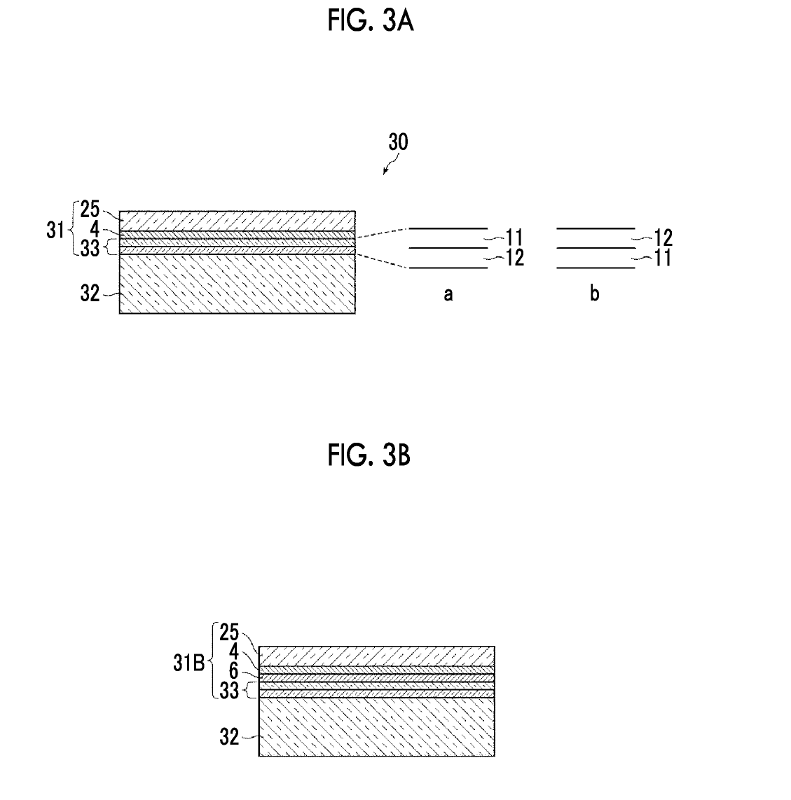

FIG. 3A is a schematic cross-sectional view showing a schematic configuration of an optical element 30 including an antireflection film 31 according to a third embodiment of the present invention.

As shown in FIG. 3A, the antireflection film 31 of the embodiment has a dielectric layer 25 having a surface to be exposed to air and formed of MgF₂, a metal layer 4 having an interface with the dielectric layer 25, containing Ag, and having a thickness of 5 nm or less, and an interlayer 33 having an interface with the metal layer 4 and constituted by a laminate formed by alternately laminating total two layers or more of a layer 11 of high refractive index having a relatively high refractive index and a layer 12 of low refractive index having a relatively low refractive index, and is laminated on a substrate 32 having a refractive index of 1.61 or more and 1.66 or less in the order of the interlayer 33, the metal layer 4, and the dielectric layer 25. The optical element 30 includes the substrate 32 having a refractive index of 1.61 or more and 1.66 or less and the antireflection film 31 formed on the surface of the substrate.

In the antireflection film 31 of the embodiment, although the material for the dielectric layer 25 is limited to MgF₂ as in the antireflection film 21 of the second embodiment, the interlayer 33 may have a two-layer structure. However, the refractive index of the substrate 32 on which the antireflection film 31 of the embodiment is formed is 1.66 or less.

The interlayer 33 may be formed by alternately laminating the layer 11 of high refractive index and the layer 12 of low refractive index, and as shown in a of FIG. 3A, the layer 12 of low refractive index and the layer 11 of high refractive index may be laminated in this order from the substrate 32. As shown in b of FIG. 3A, the layer 11 of high refractive index and the layer 12 of low refractive index may be laminated in this order from the substrate 32. In addition, the interlayer 33 may have two layers or more but it is preferable to set the number of layers to 16 or less from the viewpoint of suppressing costs.

By providing the antireflection film 31 of the embodiment arranged on the substrate 32 having a refractive index of 1.61 or more and 1.66 or less, a reflectance of 0.2% or less can be achieved with respect to light in a wavelength range of at least 450 nm to 650 nm.

It is preferable that the antireflection film 31 according to the third embodiment is also modified to an antireflection film 31B having a structure in which an anchor layer 6 between the interlayer 33 and the metal layer 4 containing Ag as shown in the design modification example in FIG. 3B. The details of the anchor layer are as described in the design modification example of the first embodiment.

The antireflection film of the present invention can be applied to the surface of various optical members. Since the antireflection film can be applied to a lens surface having a high refractive index, for example, the antireflection film is suitably used for the outermost surface of a known zoom lens described in JP2011-186417A.

An embodiment of an optical system constituted by a group lens including the antireflection film 1 of the above-described first embodiment will be described.

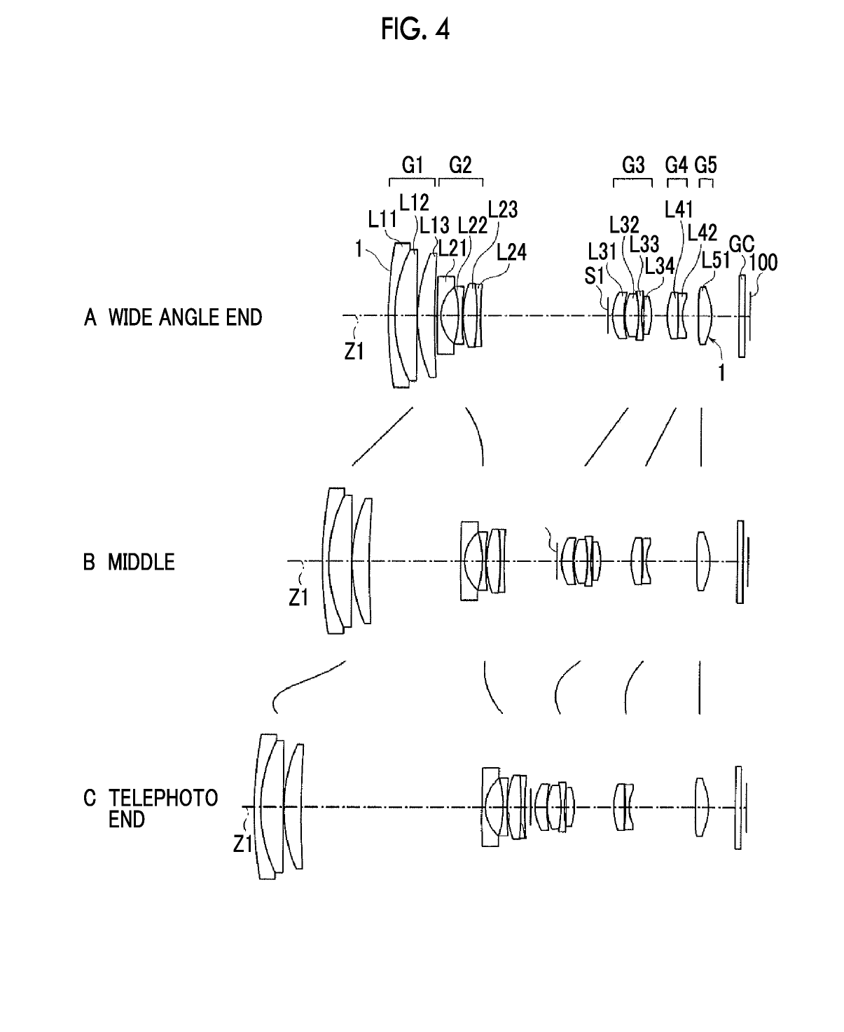

A, B, and C in FIG. 4 show configuration examples of a zoom lens which is an embodiment of the optical system of the present invention. A in FIG. 4 corresponds to an optical system arrangement at a wide angle end (shortest focal length state), B in FIG. 4 corresponds to an optical system arrangement in a middle area (intermediate focal length state), and C in FIG. 4 corresponds to an optical system arrangement at a telephoto end (longest focal length state).

The zoom lens includes a first lens group G1, a second lens group G2, a third lens group G3, a fourth lens group G4, and a fifth lens group G5 in order from an object along an optical axis Z1. An optical aperture stop 51 is preferably arranged between the second lens group G2 and the third lens group G3 in the vicinity of the third lens group G3 on the side close to the object. Each of the lens groups G1 to G5 includes one or a plurality of lenses Lij. The reference symbol Lij denotes a j-th lens with the reference symbol affixed such that a lens arranged to be closest to the object in an i-th lens group is made into the first side and the reference symbol is gradually increased toward an image forming side.

The zoom lens can be mounted in an information portable terminal as well as an imaging devices, for example, a video camera, and a digital camera. On the imaging side of the zoom lens, members are arranged according to the configuration of an imaging portion of a camera in which the lens is to be mounted. For example, an imaging element 100 such as a charge coupled device (CCD) or a complementary metal oxide semiconductor (CMOS) is arranged on an image forming surface (imaging surface) of the zoom lens. Various optical members GC may be arranged between the final lens group (fifth lens group G5) and the imaging element 100 according to the configuration of the camera side in which the lens is mounted.

The zoom lens is configured such that the magnification is changed by chaining the gaps between the individual groups by moving at least the first lens group G1, the third lens group G3, and the fourth lens group G4 along the optical axis Z1. In addition, the fourth lens group G4 may be moved at focusing. It is preferable that the fifth lens group G5 is always fixed in magnification change and at focusing. The aperture stop Si is moved together with the third lens group G3, for example. More specifically, as the magnification changes from the wide angle end to the middle area and further to the telephoto end, each lens group and the aperture stop Si is moved, for example, from the state of A in FIG. 4 to the state of B in FIG. 4 and further to the state of C in FIG. 4 along the locus indicated the solid line in the drawing.

The antireflection film 1 is provided on the outermost surfaces of the zoom lens of the outer surface (the surface close to the object) of a lens L11 of the first lens group G1 and a lens L51 of the fifth lens group G5 which is the final lens group. The antireflection film 1 may be provided other lens surfaces in the same manner.

Since the antireflection film 1 of the embodiment has high mechanical strength, the antireflection film can be provided on the outermost surface of the zoom lens which may be touched by a user and thus a zoom lens having very high antireflection performance can be formed.

In addition, in the antireflection film having a fine uneven structure, fluctuations in the refractive index are present in addition to the uneven structure and thus there is a concern of scattering occurring due to the fluctuations in the refractive index. However, since almost no fluctuations the in refractive index are present in the antireflection film of the present invention having an uneven structure, scattering hardly occurs. In the antireflection film in a camera lens, scattering causes the occurrence of flare and thus a contrast in an image is lowered. Thus, scattering is suppressed by providing the antireflection film of the present invention, and as a result, it is possible to prevent a contrast in an image from being lowered.

### EXAMPLES

Hereinafter, Examples and Comparative Examples of the present invention will be described. The optimization of the film thickness and the simulation of the wavelength dependence of the reflectance were performed by using Essential Macleod (developed by Thin Film Center Inc.).

### Examples 1-1 and 1-2

Layer configurations from a substrate to air as a medium were set as shown in Table 2.

The refractive index of the substrate was 1.61, the interlayer adopted a two-layer structure including a SiO₂ layer having a refractive index of 1.46235 as a layer of low refractive index and a Nb₂O₅ layer having a refractive index of 2.3955 as a layer of high refractive index, the metal layer was formed of Ag, and the dielectric layer was formed of MgF₂. Then, the optimization of the film thickness was performed so as to minimize the reflectance. In the following table, 1.61 in the substrate constitutional material column means a material having a refractive index of 1.61.

In Example 1-1, as the refractive index of Ag, the refractive index shown in “Optical constants of metals, in American Institute of Physics Handbook, McGraw Hill Book Company: New York and London. p. 6.124-6.156” (hereinafter, referred to as “Reference Document 2”) was used. On the other hand, in Example 1-2, as the refractive index of Ag, the refractive index shown in Reference Document 1 was used.

TABLE 2

| | Example 1-1 | | | Example 1-2 | | |
|---|---|---|---|---|---|---|
| | Constitutional | Refractive | Physical film | Constitutional | Refractive | Physical film |
| Layer | material | index | thickness (nm) | material | index | thickness (nm) |
| Medium | Air | 1 | — | Air | 1 | — |
| Dielectric | MgF₂ | 1.3857 | 88.11 | MgF₂ | 1.3857 | 87.24 |
| layer | | | | | | |
| Metal layer | Ag | 0.05 | 1 | Ag (1) | 0.13 | 4.46 |
| Interlayer 1 | Nb₂O₅ | 2.3955 | 14.52 | Nb₂O₅ | 2.3955 | 14.37 |
| Interlayer 2 | SiO₂ | 1.46235 | 177.93 | SiO₂ | 1.46235 | 177.02 |
| Substrate | 1.61 | 1.61 | — | 1.61 | 1.61 | — |

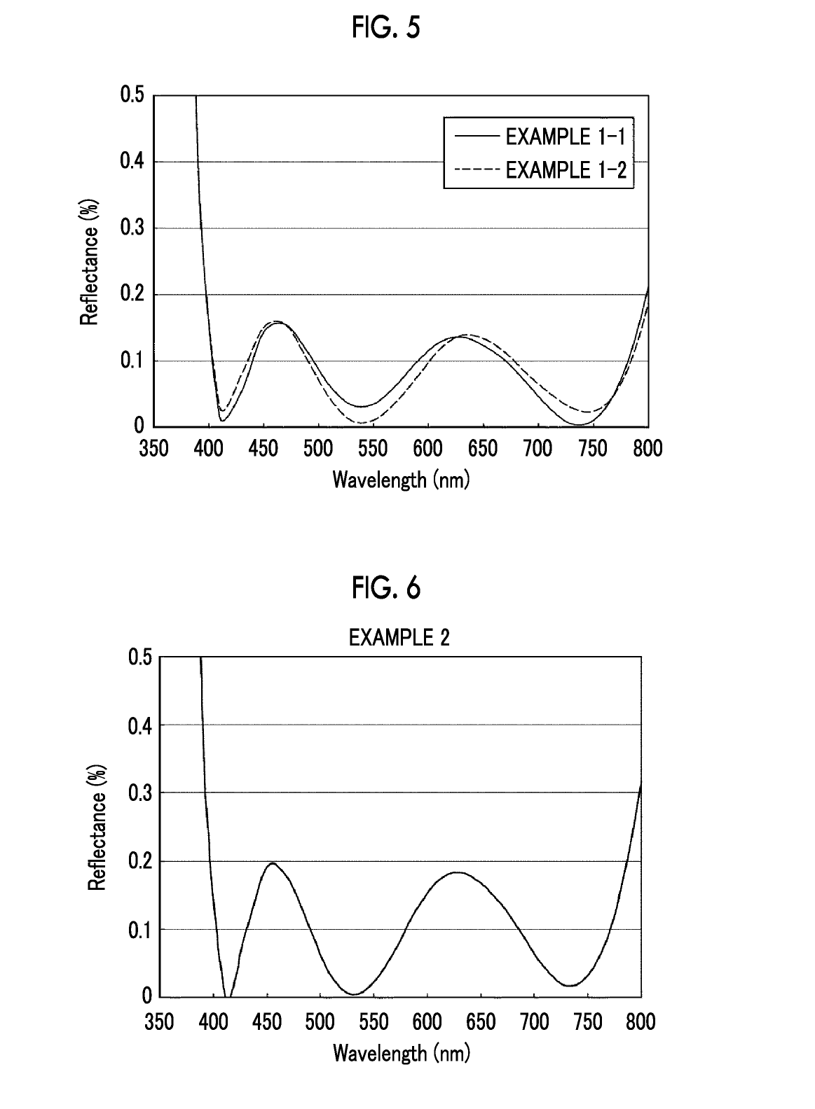

The simulation results of the reflectance of each of the antireflection films of Examples 1-1 and 1-2 with respect to light incident at a light incidence angle of 0° (light vertically incident to the surface) are shown in FIG. 5. As shown in FIG. 5, each of the antireflection films of the examples exhibited a reflectance of 0.2% or less over a wide wavelength range of 400 nm to 800 nm and satisfactory antireflection properties were obtained.

In addition, as shown in FIG. 5, in a case in which any of refractive indices described in Reference Documents 1 and 2 was used for Ag, it was found that the same antireflection properties were also obtained.

In the following examples and comparative examples, unless otherwise particularly specified, the refractive index of Ag described in Reference Document 2 was used for calculation.

### Example 2

A layer configuration from a substrate to air as a medium was set as shown in Table 3.

S-NBH5 (manufactured by OHARA INC.) was used for the substrate, the interlayer adopted a two-layer structure including a SiO₂ layer having a refractive index of 1.46235 as a layer of low refractive index and a Nb₂O₅ layer having a refractive index of 2.3955 as a layer of high refractive index, the metal layer was formed of Ag, and the dielectric layer was formed of MgF₂. Then, the optimization of the film thickness was performed so as to minimize the reflectance.

TABLE 3
Example 2

| | Constitutional | | Physical film |
|---|---|---|---|
| Layer | material | Refractive index | thickness (nm) |
| Medium | Air | 1 | — |
| Dielectric layer | MgF₂ | 1.3857 | 87.28 |
| Metal layer | Ag | 0.05 | 4.62 |
| Interlayer 1 | Nb₂O₅ | 2.3955 | 15.52 |
| Interlayer 2 | SiO₂ | 1.46235 | 176.51 |
| Substrate | S-NBH 5 | 1.66393 | — |

The simulation result of the reflectance of the antireflection film of Example 2 with respect to light incident at a light incidence angle of 0° (light vertically incident to the surface) is shown in FIG. 6. As shown in FIG. 6, the antireflection film of the example exhibited a reflectance of 0.2% or less over a wide wavelength range of 400 nm to 780 nm and satisfactory antireflection properties were obtained.

### Example 3

A layer configuration from a substrate to air as a medium was set as shown in Table 4.

S-LAL18 (manufactured by OHARA INC.) was used for the substrate, the interlayer adopted a three-layer structure in which a SiO₂ layer having a refractive index of 1.46235 as a layer of low refractive index and a Nb₂O₅ layer having a refractive index of 2.3955 as a layer of high refractive index were alternately laminated, the metal layer was formed of Ag, and the dielectric layer was formed of MgF₂. Then, the optimization of the film thickness was performed so as to minimize the reflectance.

TABLE 4
Example 3

| | Constitutional | | Physical film thickness |
|---|---|---|---|
| Layer | material | Refractive index | (nm) |
| Medium | Air | 1 | — |
| Dielectric | MgF₂ | 1.3857 | 92.53 |
| layer | | | |
| Metal layer | Ag | 0.05 | 2.58 |
| Interlayer 1 | Nb₂O₅ | 2.3955 | 18.68 |
| Interlayer 2 | SiO₂ | 1.46235 | 38.53 |
| Interlayer 3 | Nb₂O₅ | 2.3955 | 7.26 |
| Substrate | S-LAL18 | 1.73702 | — |

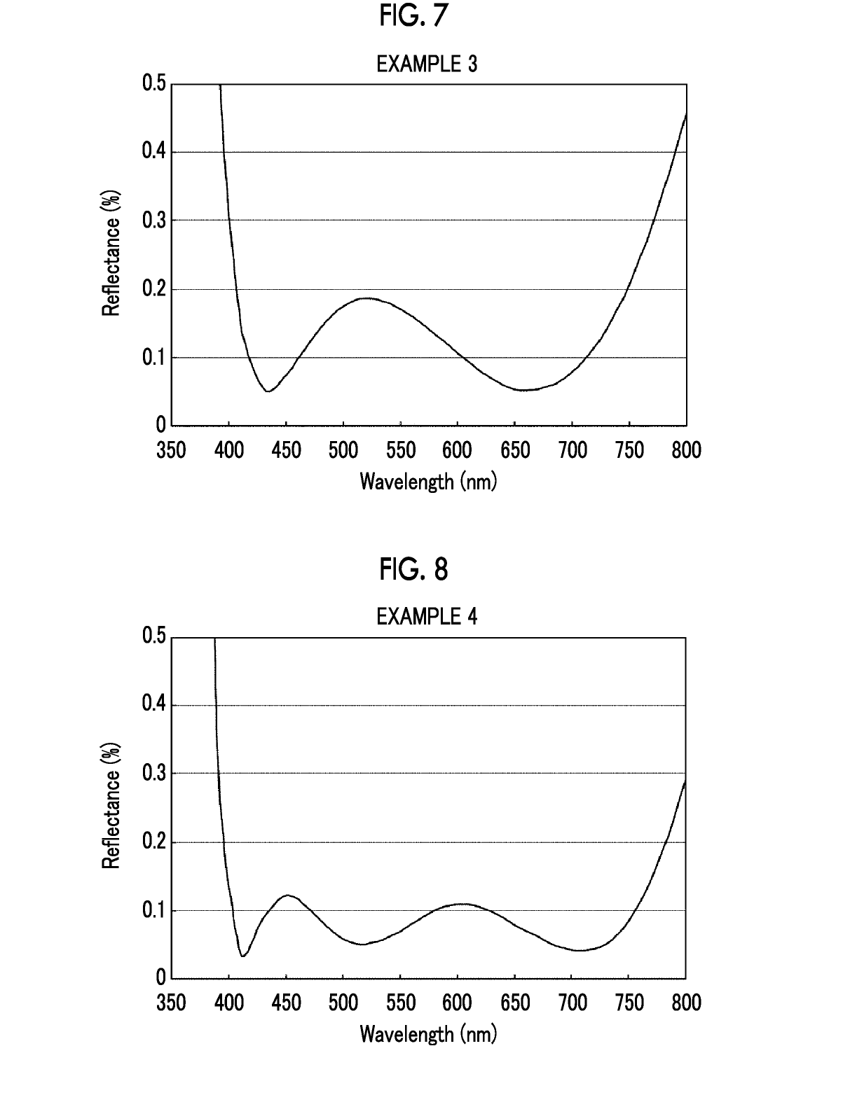

The simulation result of the reflectance of the antireflection film of Example 3 with respect to light incident at a light incidence angle of 0° (light vertically incident to the surface) is shown in FIG. 7. As shown in FIG. 7, the antireflection film of the example exhibited a reflectance of 0.2% or less over a wide wavelength range of 400 nm to 780 nm and satisfactory antireflection properties were obtained.

### Example 4

A layer configuration from a substrate to air as a medium was set as shown in Table 5.

FDS90 (manufactured by HOYA Corporation) was used for the substrate, the interlayer adopted a four-layer structure in which a SiO₂ layer having a refractive index of 1.46235 as a layer of low refractive index and a Nb₂O₅ layer having a refractive index of 2.3955 as a layer of high refractive index were alternately laminated, the metal layer was formed of Ag, and the dielectric layer was formed of MgF₂. Then, the optimization of the film thickness was performed so as to minimize the reflectance.

TABLE 5
Example 4

| | Constitutional | Refractive | Physical film |
|---|---|---|---|
| Layer | material | index | thickness (nm) |
| Medium | Air | 1 | — |
| Dielectric layer | MgF₂ | 1.3857 | 92.94 |
| Metal layer | Ag | 0.05 | 3.07 |
| Interlayer 1 | Nb₂O₅ | 2.3955 | 22 |
| Interlayer 2 | SiO₂ | 1.46235 | 47.22 |
| Interlayer 3 | Nb₂O₅ | 2.3955 | 17.85 |
| Interlayer 4 | SiO₂ | 1.46235 | 25.5 |
| Substrate | FDS90 | 1.86814 | — |

The simulation result of the reflectance of the antireflection film of Example 4 with respect to light incident at a light incidence angle of 0° (light vertically incident to the surface) is shown in FIG. 8. As shown in FIG. 8, the antireflection film of the example exhibited a reflectance of 0.2% or less over a wide wavelength range of 400 nm to 780 nm and satisfactory antireflection properties were obtained.

### Example 5

A layer configuration from a substrate to air as a medium was set as shown in Table 6.

L-BBH1 (manufactured by OHARA INC.) was used for the substrate, the interlayer adopted a four-layer structure in which a SiO₂ layer having a refractive index of 1.46235 as a layer of low refractive index and a Nb₂O₅ layer having a refractive index of 2.3955 as a layer of high refractive index were alternately laminated, the metal layer was formed of Ag, and the dielectric layer was formed of MgF₂. Then, the optimization of the film thickness was performed so as to minimize the reflectance.

TABLE 6
Example 5

| | Constitutional | | Physical film |
|---|---|---|---|
| Layer | material | Refractive index | thickness (nm) |
| Medium | Air | 1 | — |
| Dielectric layer | MgF₂ | 1.3857 | 92.94 |
| Metal layer | Ag | 0.05 | 2.75 |
| Interlayer 1 | Nb₂O₅ | 2.3955 | 24.09 |
| Interlayer 2 | SiO₂ | 1.46235 | 38.02 |
| Interlayer 3 | Nb₂O₅ | 2.3955 | 26.02 |
| Interlayer 4 | SiO₂ | 1.46235 | 17.86 |
| Substrate | L-BBH1 | 2.14346 | — |

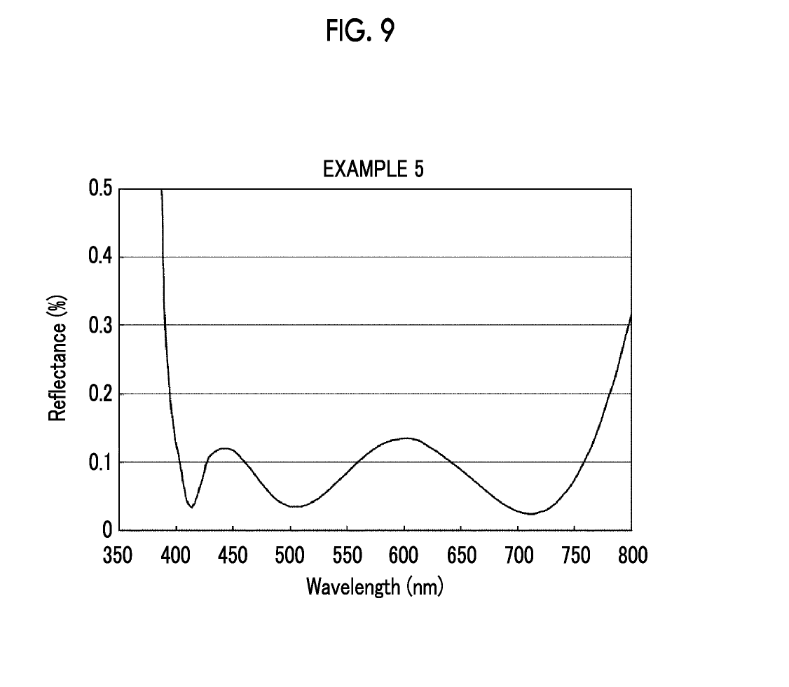

The simulation result of the reflectance of the antireflection film of Example 5 with respect to light incident at a light incidence angle of 0° (light vertically incident to the surface) is shown in FIG. 9. As shown in FIG. 9, the antireflection film of the example exhibited a reflectance of 0.2% or less over a wide wavelength range of 400 nm to 780 nm and satisfactory antireflection properties were obtained.

### Example 6

Each layer configuration from a substrate to air as a medium was set as shown in Table 7.

FDS90 was used for the substrate, each interlayer respectively adopted a four-layer structure (Example 6-1) in which a SiO₂ layer having a refractive index of 1.46235 as a layer of low refractive index and a Nb₂O₅ layer having a refractive index of 2.3955 as a layer of high refractive index were alternately laminated, a five layer structure (Example 6-2), a six layer structure (Example 6-3), a seven layer structure (Example 6-4), an eight layer structure (Example 6-5), a twelve layer structure (Example 6-6), and a sixteen-layer structure (Example 6-7), the metal layer was formed of Ag, and the dielectric layer was formed of MgF₂. Then, the optimization of the film thickness was performed in each example so as to minimize the reflectance.

TABLE 7
Example 6

| | | | | | | Example 6-4 | Example 6-5 | Example 6-6 | Example 6-7 |
|---|---|---|---|---|---|---|---|---|---|
| | | | Example 6-1 | Example 6-2 | Example 6-3 | Physical film | Physical film | Physical film | Physical film |
| | Constitutional | Refractive | Physical film | Physical film | Physical film | thickness | thickness | thickness | thickness |
| Layer | material | index | thickness (nm) | thickness (nm) | thickness (nm) | (nm) | (nm) | (nm) | (nm) |
| Medium | Air | 1 | — | — | — | — | — | — | — |
| Dielectric | MgF₂ | 1.3857 | 92.94 | 92.79 | 91.07 | 91 | 90.54 | 90.58 | 89.55 |
| layer | | | | | | | | | |
| Metal layer | Ag | 0.05 | 3.07 | 3.2 | 4.01 | 4.19 | 4.16 | 4.32 | 4.53 |
| Interlayer 1 | Nb₂O₅ | 2.3955 | 22 | 22.11 | 18.88 | 18.4 | 17.52 | 17.56 | 16.34 |
| Interlayer 2 | SiO₂ | 1.46235 | 47.22 | 48.98 | 73.06 | 83.53 | 82.92 | 94.22 | 118.14 |
| Interlayer 3 | Nb₂O₅ | 2.3955 | 17.85 | 18.46 | 9.78 | 8.03 | 6 | 5.96 | 5.35 |
| Interlayer 4 | SiO₂ | 1.46235 | 25.5 | 35.63 | 65.78 | 72.05 | 71.83 | 74.88 | 63.99 |
| Interlayer 5 | Nb₂O₅ | 2.3955 | — | 5.62 | 13.57 | 16.63 | 10.53 | 16.3 | 20.98 |
| Interlayer 6 | SiO₂ | 1.46235 | — | — | 22.38 | 35.32 | 28.46 | 30.24 | 31.57 |
| Interlayer 7 | Nb₂O₅ | 2.3955 | — | — | — | 8.39 | 8.61 | 4.72 | 9.43 |
| Interlayer 8 | SiO₂ | 1.46235 | — | — | — | — | 11.54 | 10.33 | 9.66 |
| Interlayer 9 | Nb₂O₅ | 2.3955 | — | — | — | — | — | 12.53 | 19.42 |
| Interlayer 10 | SiO₂ | 1.46235 | — | — | — | — | — | 15.66 | 20.41 |
| Interlayer 11 | Nb₂O₅ | 2.3955 | — | — | — | — | — | 7.54 | 8.54 |
| Interlayer 12 | SiO₂ | 1.46235 | — | — | — | — | — | 4.51 | 9.3 |
| Interlayer 13 | Nb₂O₅ | 2.3955 | — | — | — | — | — | — | 9.67 |
| Interlayer 14 | SiO₂ | 1.46235 | — | — | — | — | — | — | 14.14 |
| Interlayer 15 | Nb₂O₅ | 2.3955 | — | — | — | — | — | — | 9.47 |
| Interlayer 16 | SiO₂ | 1.46235 | — | — | — | — | — | — | 5.69 |
| Substrate | FDS90 | 1.86814 | — | — | — | — | — | — | — |

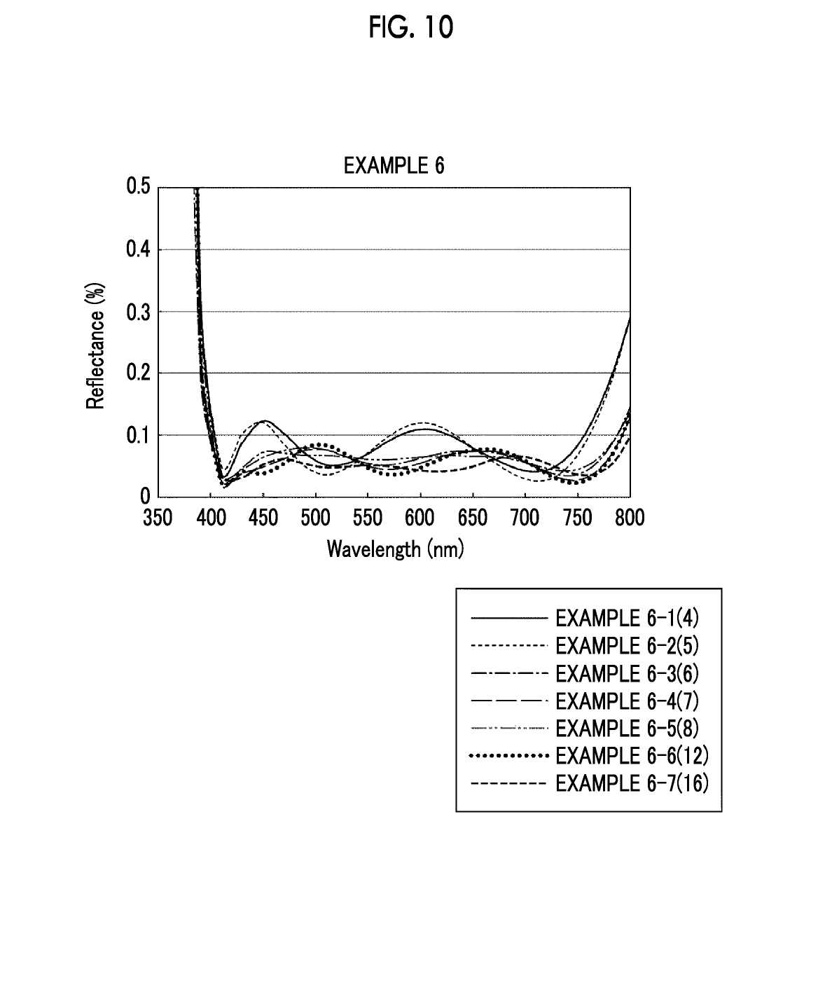

The simulation results of the reflectance of each antireflection film of Example 6 with respect to light incident at a light incidence angle of 0° (light vertically incident to the surface) are shown in FIG. 10. The numbers in the parentheses after each example shown in the explanatory note refer to the total number of interlayers. As shown in FIG. 10, the antireflection films of Examples 6-1 and 6-2 exhibited a reflectance of 0.2% or less over a wide wavelength range of 400 nm to 780 nm, and the antireflection films of Examples 6-3, 6-4, 6-5, 6-6, and 6-7 exhibited a reflectance of 0.2% or less over a wider wavelength range of 400 nm to 800 nm and exhibited a reflectance of 0.1% or less in a wavelength range of 400 nm to 780 nm. Very satisfactory antireflection properties were obtained.

### Example 7

A layer configuration from a substrate to air as a medium was set as shown in Table 8.

The refractive index of the substrate was set to 1.61, the interlayer adopted a four-layer structure in which a SiO₂ layer having a refractive index of 1.46235 as a layer of low refractive index and a Nb₂O₅ layer having a refractive index of 2.3955 as a layer of high refractive index were alternately laminated, the metal layer was formed of Ag, and the dielectric layer was formed of SiO₂. Then, the optimization of the film thickness was performed so as to minimize the reflectance.

TABLE 8
Example 7

| | Constitutional | | Physical film |
|---|---|---|---|
| Layer | material | Refractive index | thickness (nm) |
| Medium | Air | 1 | — |
| Dielectric layer | SiO₂ | 1.46235 | 81.97 |
| Metal layer | Ag | 0.05 | 5 |
| Interlayer 1 | Nb₂O₅ | 2.3955 | 21.62 |
| Interlayer 2 | SiO₂ | 1.46235 | 64.84 |
| Interlayer 3 | Nb₂O₅ | 2.3955 | 6.3 |
| Interlayer 4 | SiO₂ | 1.46235 | 64.13 |
| Substrate | 1.61 | 1.61 | — |

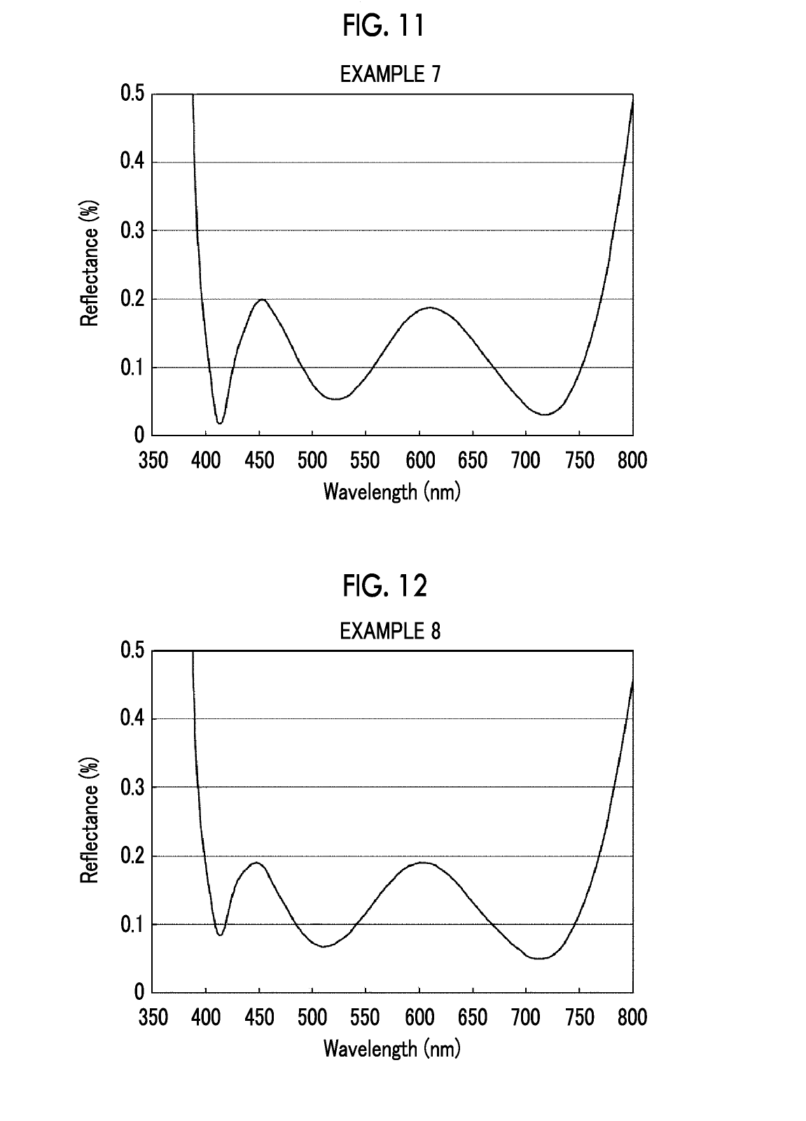

The simulation result of the reflectance of the antireflection film of Example 7 with respect to light incident at a light incidence angle of 0° (light vertically incident to the surface) is shown in FIG. 11. As shown in FIG. 11, the antireflection film of the example exhibited a reflectance of 0.2% or less over a wide wavelength range of 400 nm to 780 nm and satisfactory antireflection properties were obtained.

### Example 8

A layer configuration from a substrate to air as a medium was set as shown in Table 9.

S-LAL18 was used for the substrate, the interlayer adopted a four-layer structure in which a SiO₂ layer having a refractive index of 1.46235 as a layer of low refractive index and a Nb₂O₅ layer having a refractive index of 2.3955 as a layer of high refractive index were alternately laminated, the metal layer was formed of Ag, and the dielectric layer was formed of SiO₂. Then, the optimization of the film thickness was performed so as to minimize the reflectance.

TABLE 9
Example 8

| | Constitutional | | Physical film |
|---|---|---|---|
| Layer | material | Refractive index | thickness (nm) |
| Medium | Air | 1 | — |
| Dielectric layer | SiO₂ | 1.46235 | 83.6 |
| Metal layer | Ag | 0.05 | 4.37 |
| Interlayer 1 | Nb₂O₅ | 2.3955 | 24.61 |
| Interlayer 2 | SiO₂ | 1.46235 | 50.65 |
| Interlayer 3 | Nb₂O₅ | 2.3955 | 13.51 |
| Interlayer 4 | SiO₂ | 1.46235 | 34.27 |
| Substrate | S-LAL18 | 1.73702 | — |

The simulation result of the reflectance of the antireflection film of Example 8 with respect to light incident at a light incidence angle of 0° (light vertically incident to the surface) is shown in FIG. 12. As shown in FIG. 12, the antireflection film of the example exhibited a reflectance of 0.2% or less over a wide wavelength range of 400 nm to 770 nm and satisfactory antireflection properties were obtained.

### Example 9

A layer configuration from a substrate to air as a medium was set as shown in Table 10.

FDS90 was used for the substrate, the interlayer adopted a four-layer structure in which a SiO₂ layer having a refractive index of 1.46235 as a layer of low refractive index and a Nb₂O₅ layer having a refractive index of 2.3955 as a layer of high refractive index were alternately laminated, the metal layer was formed of Ag, and the dielectric layer was formed of SiO₂. Then, the optimization of the film thickness was performed so as to minimize the reflectance.

TABLE 10
Example 9

| | Constitutional | Refractive | Physical film |
|---|---|---|---|
| Layer | material | index | thickness (nm) |
| Medium | Air | 1 | — |
| Dielectric layer | SiO₂ | 1.46235 | 84.01 |
| Metal layer | Ag | 0.05 | 4.13 |
| Interlayer 1 | Nb₂O₅ | 2.3955 | 25.95 |
| Interlayer 2 | SiO₂ | 1.46235 | 45.4 |
| Interlayer 3 | Nb₂O₅ | 2.3955 | 17.65 |
| Interlayer 4 | SiO₂ | 1.46235 | 27.64 |
| Substrate | FDS90 | 1.86814 | — |

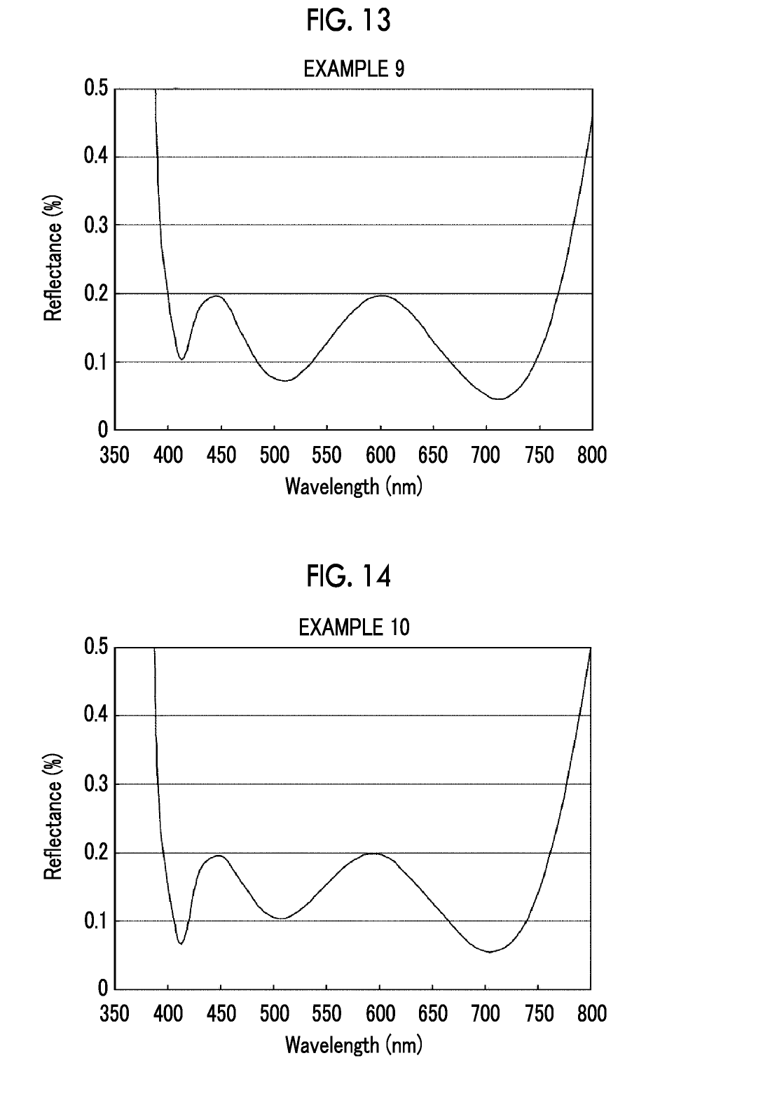

The simulation result of the reflectance of the antireflection film of Example 9 with respect to light incident at a light incidence angle of 0° (light vertically incident to the surface) is shown in FIG. 13. As shown in FIG. 13, the antireflection film of the example exhibited a reflectance of 0.2% or less over a wide wavelength range of 400 nm to 770 nm and satisfactory antireflection properties were obtained.

### Example 10

A layer configuration from a substrate to air as a medium was set as shown in Table 11.

L-BBH1 was used for the substrate, the interlayer adopted a four-layer structure in which a SiO₂ layer having a refractive index of 1.46235 as a layer of low refractive index and a Nb₂O₅ layer having a refractive index of 2.3955 as a layer of high refractive index were alternately laminated, the metal layer was formed of Ag, and the dielectric layer was formed of SiO₂. Then, the optimization of the film thickness was performed so as to minimize the reflectance.

TABLE 11
Example 10

| | Constitutional | Refractive | Physical film |
|---|---|---|---|
| Layer | material | index | thickness (nm) |
| Medium | Air | 1 | — |
| Dielectric | SiO₂ | 1.46235 | 84.32 |
| layer | | | |
| Metal layer | Ag | 0.05 | 3.54 |
| Interlayer 1 | Nb₂O₅ | 2.3955 | 28.54 |
| Interlayer 2 | SiO₂ | 1.46235 | 33.93 |
| Interlayer 3 | Nb₂O₅ | 2.3955 | 27.26 |
| Interlayer 4 | SiO₂ | 1.46235 | 16.88 |
| Substrate | L-BBH1 | 2.14346 | — |

The simulation result of the reflectance of the antireflection film of Example 10 with respect to light incident at a light incidence angle of 0° (light vertically incident to the surface) is shown in FIG. 14. As shown in FIG. 14, the antireflection film of the example exhibited a reflectance of 0.2% or less over a wide wavelength range of 400 nm to 760 nm and satisfactory antireflection properties were obtained.

### Example 11

Layer configurations from a substrate to air as a medium were set as shown in Table 12.

FDS90 was used for the substrate, each interlayer respectively adopted a four-layer structure (Example 11-1) in which a SiO₂ layer having a refractive index of 1.46235 as a layer of low refractive index and a Nb₂O₅ layer having a refractive index of 2.3955 as a layer of high refractive index were alternately laminated, a five-layer structure (Example 11-2), a six-layer structure (Example 11-3), a seven-layer structure (Example 11-4), an eight-layer structure (Example 11-5), a twelve-layer structure (Example 11-6) and a sixteen-layer structure (Example 11-7), the metal layer was formed of Ag, and the dielectric layer was formed of SiO₂. Then, the optimization of the film thickness was performed in each example so as to minimize the reflectance.

TABLE 12
Example 11

| | | | | | | Example | Example | Example | Example |
|---|---|---|---|---|---|---|---|---|---|
| | | | | | | 11-4 | 11-5 | 11-6 | 11-7 |
| | | | Example 11-1 | Example 11-2 | Example 11-3 | Physical film | Physical film | Physical film | Physical film |
| | Constitutional | Refractive | Physical film | Physical film | Physical film | thickness | thickness | thickness | thickness |
| Layer | material | index | thickness (nm) | thickness (nm) | thickness (nm) | (nm) | (nm) | (nm) | (nm) |
| Medium | Air | 1 | — | — | — | — | — | — | — |
| Dielectric | SiO₂ | 1.46235 | 81.97 | 84.16 | 83.53 | 83.41 | 83.44 | 84.6 | 84.47 |
| layer | | | | | | | | | |
| Metal layer | Ag | 0.05 | 5 | 4.01 | 5 | 5 | 5 | 5 | 5 |
| Interlayer 1 | Nb₂O₅ | 2.3955 | 21.62 | 26.21 | 21.94 | 23.17 | 21.97 | 22.22 | 22.75 |
| Interlayer 2 | SiO₂ | 1.46235 | 64.84 | 44.98 | 77.04 | 72.37 | 78.85 | 87.06 | 83.08 |
| Interlayer 3 | Nb₂O₅ | 2.3955 | 6.3 | 19.67 | 7.43 | 9.99 | 7.66 | 7.29 | 8.29 |
| Interlayer 4 | SiO₂ | 1.46235 | 64.13 | 34.95 | 75.28 | 70.97 | 76.61 | 80.71 | 80.32 |
| Interlayer 5 | Nb₂O₅ | 2.3955 | — | 6 | 13.18 | 16.87 | 16.14 | 20.48 | 20.12 |
| Interlayer 6 | SiO₂ | 1.46235 | — | — | 24.18 | 35.42 | 37.7 | 44.7 | 46.65 |
| Interlayer 7 | Nb₂O₅ | 2.3955 | — | — | — | 8.18 | 12.58 | 26.33 | 25.2 |
| Interlayer 8 | SiO₂ | 1.46235 | — | — | — | — | 6.09 | 10.81 | 8.68 |
| Interlayer 9 | Nb₂O₅ | 2.3955 | — | — | — | — | — | 2.26 | 1.01 |
| Interlayer 10 | SiO₂ | 1.46235 | — | — | — | — | — | 24.62 | 26.69 |
| Interlayer 11 | Nb₂O₅ | 2.3955 | — | — | — | — | — | 18.25 | 15.16 |
| Interlayer 12 | SiO₂ | 1.46235 | — | — | — | — | — | 9.7 | 8.5 |
| Interlayer 13 | Nb₂O₅ | 2.3955 | — | — | — | — | — | — | 2.01 |
| Interlayer 14 | SiO₂ | 1.46235 | — | — | — | — | — | — | 6.2 |
| Interlayer 15 | Nb₂O₅ | 2.3955 | — | — | — | — | — | — | 6.65 |
| Interlayer 16 | SiO₂ | 1.46235 | — | — | — | — | — | — | 7.69 |
| Substrate | FDS90 | 1.86814 | — | — | — | — | — | — | — |

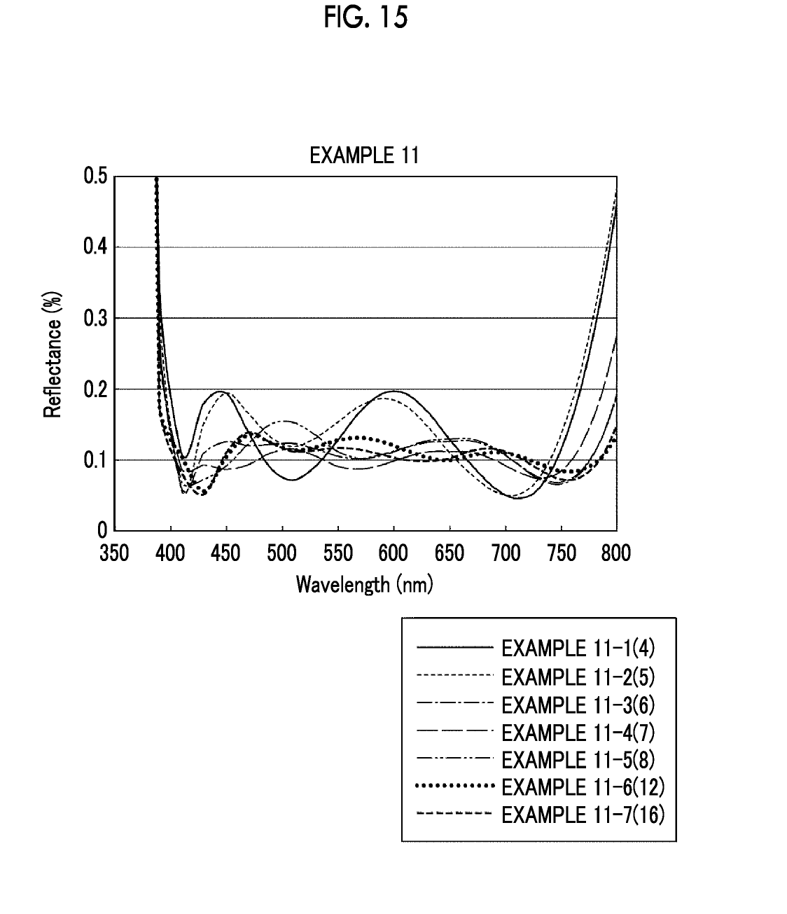

The simulation results of the reflectance of each antireflection films of Example 11 with respect to light incident at a light incidence angle of 0° (light vertically incident to the surface) are shown in FIG. 15. As shown in FIG. 15, the antireflection films of Examples 11-1 and 11-2 exhibited a reflectance of 0.2% or less over a wide wavelength range of 400 nm to 760 nm, and the antireflection films of Examples 11-3, 11-4, and 11-5 exhibited a reflectance of 0.2% or less over a wider wavelength range of 400 nm to 780 nm. Particularly, the antireflection films of Examples 11-4 and 11-5 exhibited a reflectance of 0.15% or less in a wavelength range of 400 nm to 780 nm. Furthermore, the antireflection films of Examples 11-6 and 11-7 exhibited a reflectance of 0.15% or less in a wavelength range of 400 nm to 800 nm. Satisfactory antireflection properties were obtained in all of the antireflection films.

### Example 12

A layer configuration from a substrate to air as a medium was set as shown in Table 13.

L-BBH1 was used for the substrate, the interlayer adopted a four-layer structure in which a SiO₂ layer having a refractive index of 1.46235 as a layer of low refractive index and a Nb₂O₅ layer having a refractive index of 2.3955 as a layer of high refractive index were alternately laminated, the metal layer was formed of Ag, and the dielectric layer was formed of SiON. Then, the optimization of the film thickness was performed so as to minimize the reflectance.

TABLE 13
Example 12

| | Constitutional | | Physical film |
|---|---|---|---|
| Layer | material | Refractive index | thickness (nm) |
| Medium | Air | 1 | — |
| Dielectric layer | SiON | 1.50291 | 78.09 |
| Metal layer | Ag | 0.05 | 4.52 |
| Interlayer 1 | Nb₂O₅ | 2.3955 | 30.6 |
| Interlayer 2 | SiO₂ | 1.46235 | 34.49 |
| Interlayer 3 | Nb₂O₅ | 2.3955 | 26.26 |
| Interlayer 4 | SiO₂ | 1.46235 | 17.33 |
| Substrate | L-BBH1 | 2.14346 | — |

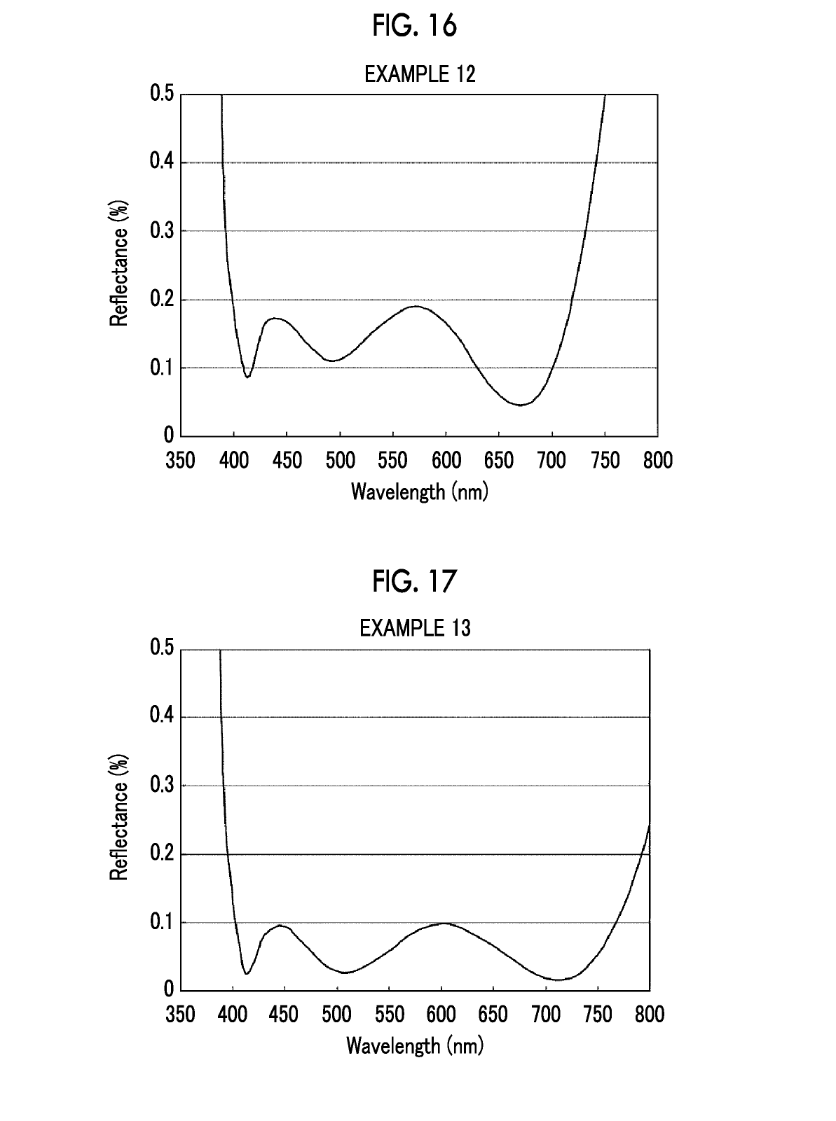

The simulation result of the reflectance of the antireflection film of Example 12 with respect to light incident at a light incidence angle of 0° (light vertically incident to the surface) is shown in FIG. 16. As shown in FIG. 16, the antireflection film of the example exhibited a reflectance of 0.2% or less over a wide wavelength range of 400 nm to 720 nm and satisfactory antireflection properties were obtained.

### Example 13

A layer configuration from a substrate to air as a medium was set as shown in Table 14.

L-BBH1 was used for the substrate, the interlayer adopted a four-layer structure in which a SiO₂ layer having a refractive index of 1.46235 as a layer of low refractive index and a Nb₂O₅ layer having a refractive index of 2.3955 as a layer of high refractive index were alternately laminated, the metal layer was formed of Ag, and the dielectric layer was formed of Na₃AlF₆. Then, the optimization of the film thickness was performed so as to minimize the reflectance.

TABLE 14
Example 13

| | Constitutional | | Physical film |
|---|---|---|---|
| Layer | material | Refractive index | thickness (nm) |
| Medium | Air | 1 | — |
| Dielectric layer | Na₃AlF₆ | 1.35 | 97.74 |
| Metal layer | Ag | 0.05 | 2.29 |
| Interlayer 1 | Nb₂O₅ | 2.3955 | 21.86 |
| Interlayer 2 | SiO₂ | 1.46235 | 39.68 |
| Interlayer 3 | Nb₂O₅ | 2.3955 | 25.71 |
| Interlayer 4 | SiO₂ | 1.46235 | 17.49 |
| Substrate | L-BBH1 | 2.14346 | — |

The simulation result of the reflectance of the antireflection film of Example 13 with respect to light incident at a light incidence angle of 0° (light vertically incident to the surface) is shown in FIG. 17. As shown in FIG. 17, the antireflection film of the example exhibited a reflectance of 0.2% or less over a wide wavelength range of 400 nm to 790 nm and exhibited a reflectance of 0.1% or less in a wavelength range of 400 nm to 760 nm, and very satisfactory antireflection properties were obtained.

### Comparative Example 1

A layer configuration from a substrate to air as a medium was set as shown in Table 15.

The refractive index of the substrate was set to 1.61, the interlayer adopted a two-layer structure including a SiO₂ layer having a refractive index of 1.479 as a layer of low refractive index and a TiO₂ layer having a refractive index of 2.291 as a layer of high refractive index, the metal layer was formed of Ag, and the dielectric layer was formed of SiO₂. Then, the optimization of the film thickness was performed so as to minimize the reflectance. As the refractive index of Ag, the refractive index shown in Reference Document 1 was used.

TABLE 15
Comparative Example 1

| | Constitutional | | Physical film |
|---|---|---|---|
| Layer | material | Refractive index | thickness (nm) |
| Medium | Air | 1 | — |
| Dielectric layer | SiO₂ | 1.479 | 77.74 |
| Metal layer | Ag(1) | 0.13 | 6.5 |
| Interlayer 1 | TiO₂ | 2.291 | 22.13 |
| Interlayer 2 | SiO₂ | 1.479 | 171.53 |
| Substrate | 1.61 | 1.61 | — |

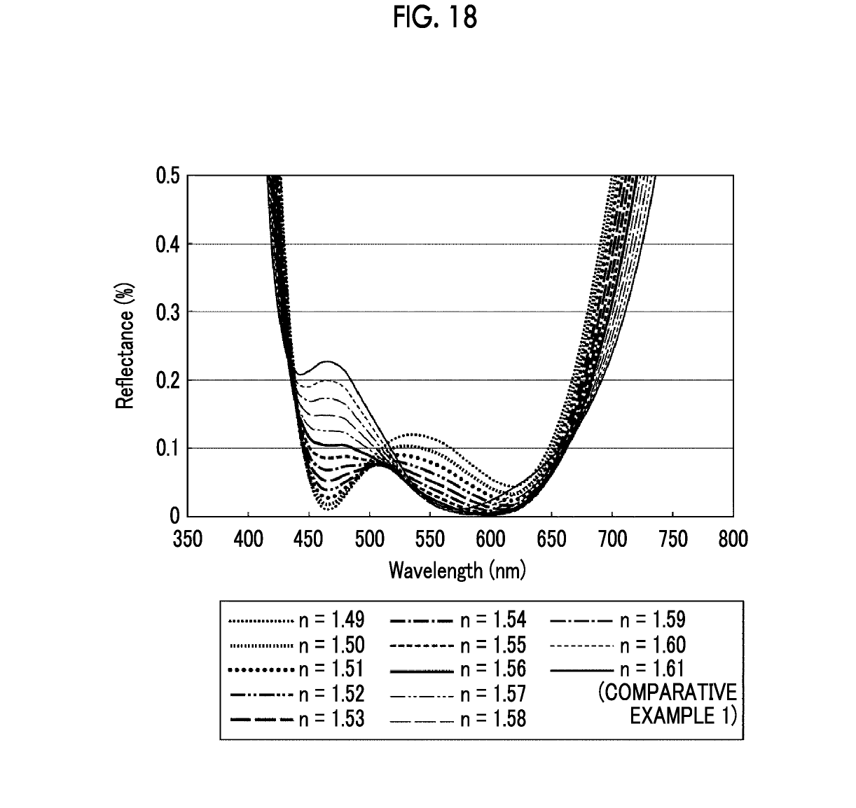

The simulation result of the reflectance of the antireflection film of Comparative Example 1 with respect to light incident at a light incidence angle of 0° (light vertically incident to the surface) corresponds to n=1.61 in FIG. 18. As shown in FIG. 18, for the antireflection film of the example, an area in which the reflectance was more than 0.2% at a wavelength of 460 nm to 480 nm was formed and desired antireflection properties in a visible light range were not obtained.

### Comparative Example 2

A layer configuration from a substrate to air as a medium was set as shown in Table 16.

The refractive index of the substrate was set to 1.61, the interlayer adopted a two-layer structure in which a SiO₂ layer having a refractive index of 1.46235 as a layer of low refractive index and a Nb₂O₅ layer having a refractive index of 2.3955 as a layer of high refractive index were laminated, the metal layer was formed of Ag, and the dielectric layer was formed of SiO₂. Then, the optimization of the film thickness was performed so as to minimize the reflectance.

TABLE 16
Comparative Example 2

| | Constitutional | | Physical film |
|---|---|---|---|
| Layer | material | Refractive index | thickness (nm) |
| Medium | Air | 1 | — |
| Dielectric layer | SiO₂ | 1.46235 | 81.24 |
| Metal layer | Ag | 0.05 | 5 |
| Interlayer 1 | Nb₂O₅ | 2.3955 | 17.18 |
| Interlayer 2 | SiO₂ | 1.46235 | 175.81 |
| Substrate | 1.61 | 1.61 | — |

The simulation result of the reflectance of the antireflection film of Comparative Example 2 with respect to light incident at a light incidence angle of 0° (light vertically incident to the surface) is shown in FIG. 19. As shown in FIG. 19, for the antireflection film of the example, an area in which the reflectance was more than 0.2% at a wavelength of 440 nm to 670 nm was formed and desired antireflection properties in a visible light range were not obtained.

### Comparative Example 3

A layer configuration from a substrate to air as a medium was set as shown in Table 17.

S-LAL18 was used for the substrate, the interlayer adopted a two-layer structure in which a SiO₂ layer having a refractive index of 1.46235 as a layer of low refractive index and a Nb₂O₅ layer having a refractive index of 2.3955 as a layer of high refractive index were laminated, the metal layer was formed of Ag, and the dielectric layer was formed of MgF₂. Then, the optimization of the film thickness was performed so as to minimize the reflectance.

TABLE 17
Comparative Example 3

| | Constitutional | | Physical film |
|---|---|---|---|
| Layer | material | Refractive index | thickness (nm) |
| Medium | Air | 1 | — |
| Dielectric | MgF₂ | 1.3857 | 84.96 |
| layer | | | |
| Metal layer | Ag | 0.05 | 4.85 |
| Interlayer 1 | Nb₂O₅ | 2.3955 | 15.08 |
| Interlayer 2 | SiO₂ | 1.46235 | 171.97 |
| Substrate | S-LAL18 | 1.73702 | — |

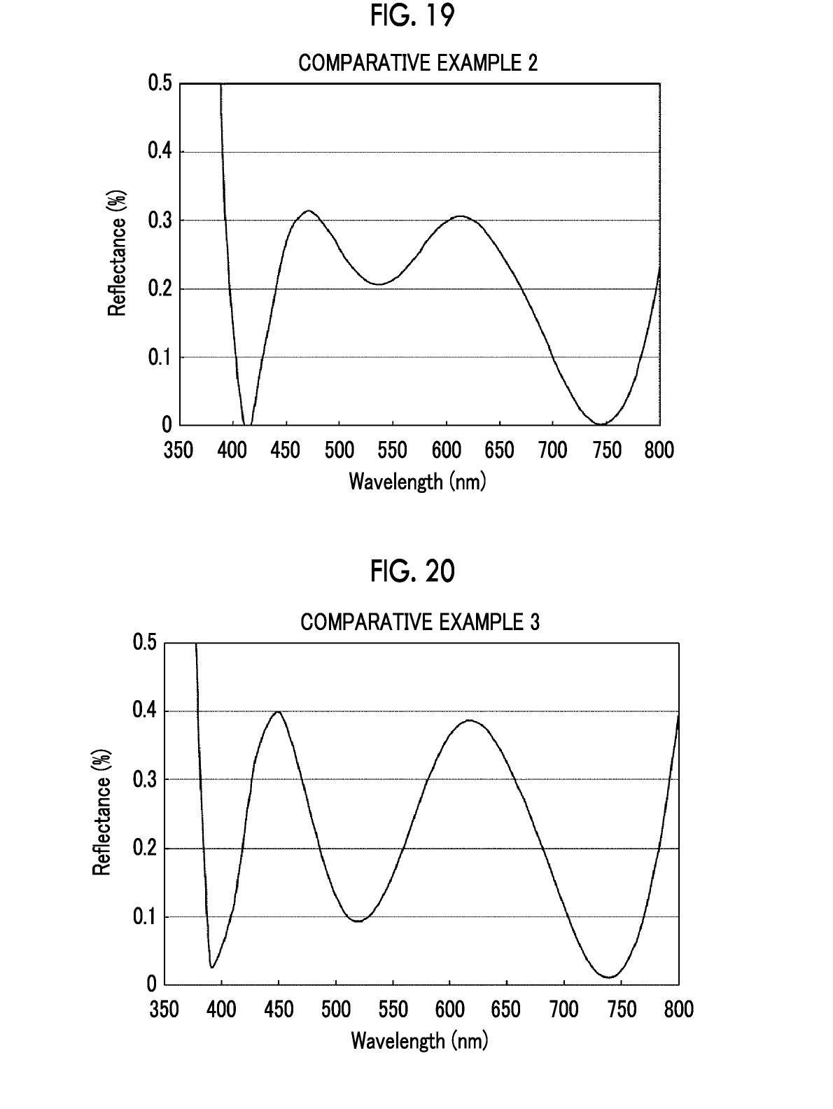

The simulation result of the reflectance of the antireflection film of Comparative Example 3 with respect to light incident at a light incidence angle of 0° (light vertically incident to the surface) is shown in FIG. 20. As shown in FIG. 20, in the antireflection film of the example, desired antireflection properties in a visible light range were not obtained.

### Comparative Example 4

A layer configuration from a substrate to air as a medium was set as shown in Table 18.

FDS90 was used for the substrate, the interlayer adopted a three-layer structure in which a SiO₂ layer having a refractive index of 1.46235 as a layer of low refractive index and a Nb₂O₅ layer having a refractive index of 2.3955 as a layer of high refractive index were alternately laminated, the metal layer was formed of Ag, and the dielectric layer was formed of MgF₂. Then, the optimization of the film thickness was performed so as to minimize the reflectance.

TABLE 18
Comparative Example 4

| | Constitutional | Refractive | Physical film |
|---|---|---|---|
| Layer | material | index | thickness (nm) |
| Medium | Air | 1 | — |
| Dielectric layer | MgF₂ | 1.3857 | 92.79 |
| Metal layer | Ag | 0.05 | 2.25 |
| Interlayer 1 | Nb₂O₅ | 2.3955 | 18.95 |
| Interlayer 2 | SiO₂ | 1.46235 | 31.84 |
| Interlayer 3 | Nb₂O₅ | 2.3955 | 6.63 |
| Substrate | FDS90 | 1.86814 | — |

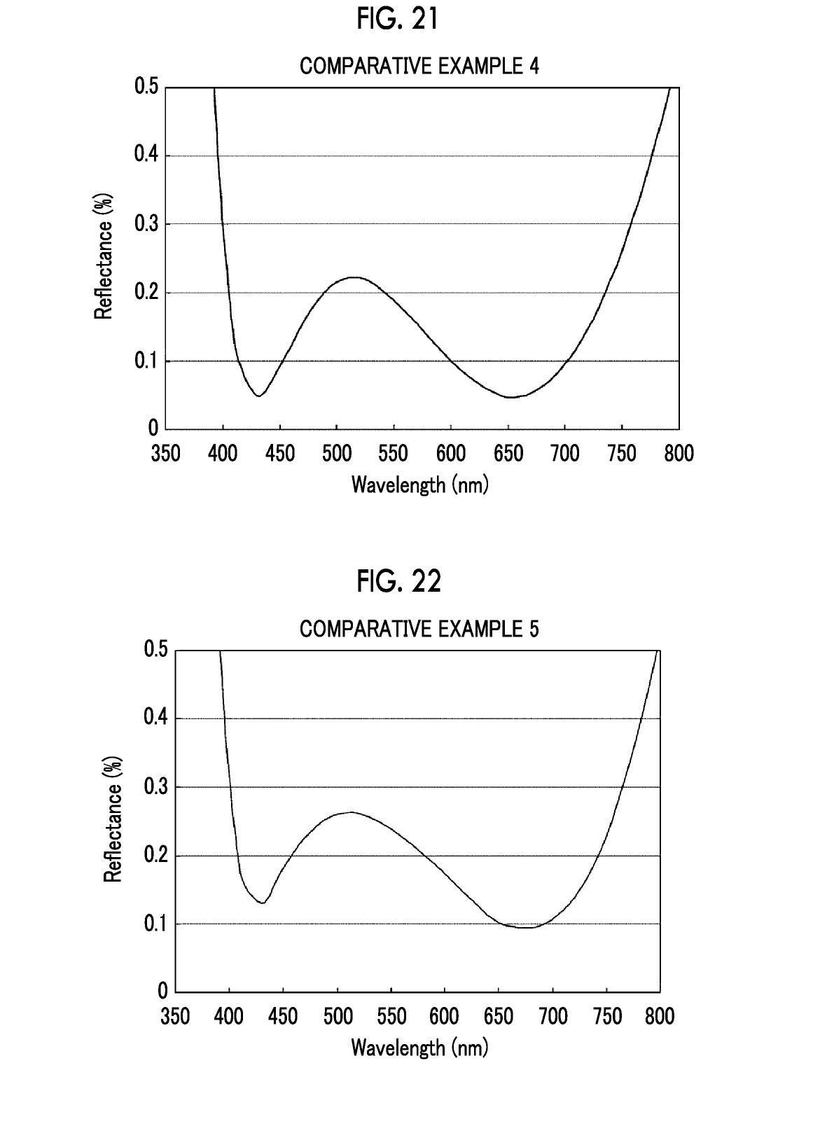

The simulation result of the reflectance of the antireflection film of Comparative Example 4 with respect to light incident at a light incidence angle of 0° (light vertically incident to the surface) is shown in FIG. 21. As shown in FIG. 21, for the antireflection film of the example, an area in which the reflectance was more than 0.2% at a wavelength of 480 nm to 540 nm was formed and desired antireflection properties in a visible light range were not obtained.

### Comparative Example 5

A layer configuration from a substrate to air as a medium was set as shown in Table 19.

The refractive index of the substrate was set to 1.61, the interlayer adopted a three-layer structure in which a SiO₂ layer having a refractive index of 1.46235 as a layer of low refractive index and a Nb₂O₅ layer having a refractive index of 2.3955 as a layer of high refractive index were alternately laminated, the metal layer was formed of Ag, and the dielectric layer was formed of SiO₂. Then, the optimization of the film thickness was performed so as to minimize the reflectance.

TABLE 19
Comparative Example 5

| | Constitutional | | Physical film |
|---|---|---|---|
| Layer | material | Refractive index | thickness (nm) |
| Medium | Air | 1 | — |
| Dielectric layer | SiO₂ | 1.46235 | 84.25 |
| Metal layer | Ag | 0.05 | 3.74 |
| Interlayer 1 | Nb₂O₅ | 2.3955 | 22.21 |
| Interlayer 2 | SiO₂ | 1.46235 | 42.97 |
| Interlayer 3 | Nb₂O₅ | 2.3955 | 8.04 |
| Substrate | 1.61 | 1.61 | — |

The simulation result of the reflectance of the antireflection film of Comparative Example 5 with respect to light incident at a light incidence angle of 0° (light vertically incident to the surface) is shown in FIG. 22. As shown in FIG. 22, for the antireflection film of the example, an area in which the reflectance was more than 0.2% at a wavelength of 460 nm to 570 nm was formed and desired antireflection properties in a visible light range were not obtained.

### Comparative Example 6

A layer configuration from a substrate to air as a medium was set as shown in Table 20.

The refractive index of the substrate was set to 1.61, the interlayer adopted a four-layer structure in which a SiO₂ layer having a refractive index of 1.46235 as a layer of low refractive index and a Nb₂O₅ layer having a refractive index of 2.3955 as a layer of high refractive index were alternately laminated, the metal layer was formed of Ag, and the dielectric layer was formed of SiO2. Then, the optimization of the film thickness was performed so as to minimize the reflectance.

TABLE 20
Comparative Example 6

| | Constitutional | | Physical film |
|---|---|---|---|
| Layer | material | Refractive index | thickness (nm) |
| Medium | Air | 1 | — |
| Dielectric layer | SiO₂ | 1.46235 | 83.18 |
| Metal layer | Ag | 0.05 | 6.1 |
| Interlayer 1 | Nb₂O₅ | 2.3955 | 22.74 |
| Interlayer 2 | SiO₂ | 1.46235 | 57.33 |
| Interlayer 3 | Nb₂O₅ | 2.3955 | 8.99 |
| Interlayer 4 | SiO₂ | 1.46235 | 47.56 |
| Substrate | 1.61 | 1.61 | — |

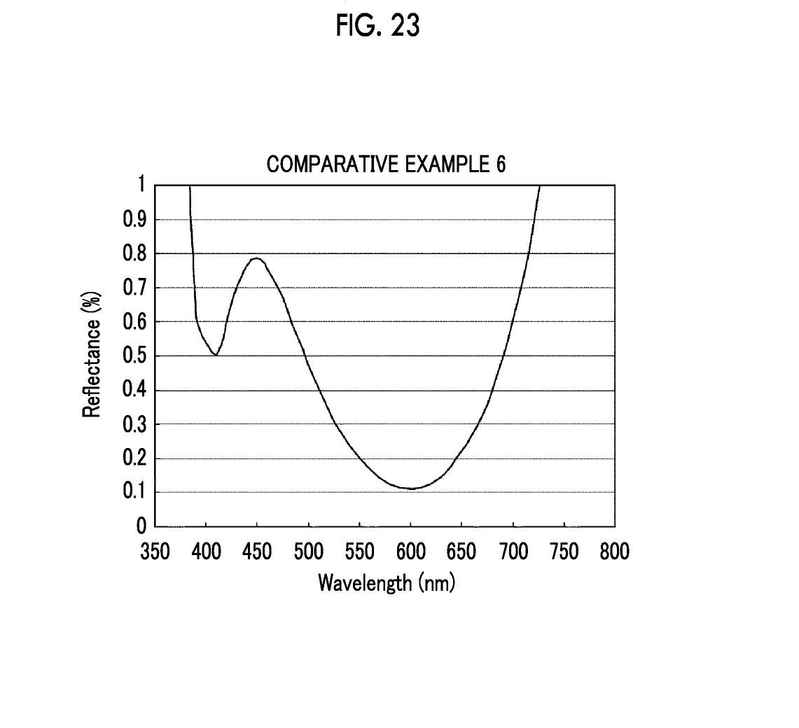

The simulation result of the reflectance of the antireflection film of Comparative Example 6 with respect to light incident at a light incidence angle of 0° (light vertically incident to the surface) is shown in FIG. 23. As shown in FIG. 23, in the antireflection film of the example, desired antireflection properties in a visible light range were not obtained.

In Table 21, the main configuration and the antireflection property evaluation of Examples 1 to 13 and Comparative Examples 1 to 6 were collectively shown.

In the antireflection property evaluation, a case in which a reflectance of 0.2% or less was achieved over the entire wavelength range of 450 nm to 650 nm was evaluated as OK, and a case in which an area in which the reflectance was more than 0.2% was formed was evaluated as NG.

TABLE 21

| | Refractive | | | | |
|---|---|---|---|---|---|
| | index of | Number of | Film thickness of | Dielectric | Reflectance of |
| | substrate | interlayers | metal layer (nm) | layer | 0.2% or less |
| Example 1-1 | 1.61 | 2 | 4.30 | MgF₂ | OK |
| Example 1-2 | 1.61 | 2 | 4.46 | MgF₂ | OK |
| Example 2 | 1.66 | 2 | 4.62 | MgF₂ | OK |
| Example 3 | 1.74 | 3 | 2.58 | MgF₂ | OK |
| Example 4 | 1.87 | 4 | 3.07 | MgF₂ | OK |
| Example 5 | 2.14 | 4 | 2.75 | MgF₂ | OK |
| Example 6-1 | 1.87 | 4 | 3.07 | MgF₂ | OK |
| Example 6-2 | 1.87 | 5 | 3.20 | MgF₂ | OK |
| Example 6-3 | 1.87 | 6 | 4.01 | MgF₂ | OK |
| Example 6-4 | 1.87 | 7 | 4.19 | MgF₂ | OK |
| Example 6-5 | 1.87 | 8 | 4.16 | MgF₂ | OK |
| Example 6-6 | 1.87 | 12 | 4.32 | MgF₂ | OK |
| Example 6-7 | 1.87 | 16 | 4.53 | MgF₂ | OK |
| Example 7 | 1.61 | 4 | 5.00 | SiO₂ | OK |
| Example 8 | 1.74 | 4 | 4.37 | SiO₂ | OK |
| Example 9 | 1.87 | 4 | 4.13 | SiO₂ | OK |
| Example 10 | 2.14 | 4 | 3.54 | SiO₂ | OK |
| Example 11-1 | 1.87 | 4 | 5.00 | SiO₂ | OK |
| Example 11-2 | 1.87 | 5 | 4.01 | SiO₂ | OK |
| Example 11-3 | 1.87 | 6 | 5.00 | SiO₂ | OK |
| Example 11-4 | 1.87 | 7 | 5.00 | SiO₂ | OK |
| Example 11-5 | 1.87 | 8 | 5.00 | SiO₂ | OK |
| Example 11-6 | 1.87 | 12 | 5.00 | SiO₂ | OK |
| Example 11-7 | 1.87 | 16 | 5.00 | SiO₂ | OK |
| Example 12 | 2.14 | 4 | 4.52 | SiON | OK |
| Example 13 | 2.14 | 4 | 2.29 | Na₃AlF₆ | OK |
| Comparative | 1.61 | 2 | 6.50 | SiO₂ | NG |
| Example 1 | | | | | |
| Comparative | 1.61 | 2 | 5.00 | SiO₂ | NG |
| Example 2 | | | | | |
| Comparative | 1.74 | 2 | 4.85 | MgF₂ | NG |
| Example 3 | | | | | |
| Comparative | 1.87 | 3 | 2.25 | MgF₂ | NG |
| Example 4 | | | | | |
| Comparative | 1.61 | 3 | 3.74 | SiO₂ | NG |
| Example 5 | | | | | |
| Comparative | 1.61 | 4 | 6.10 | SiO₂ | NG |
| Example 6 | | | | | |

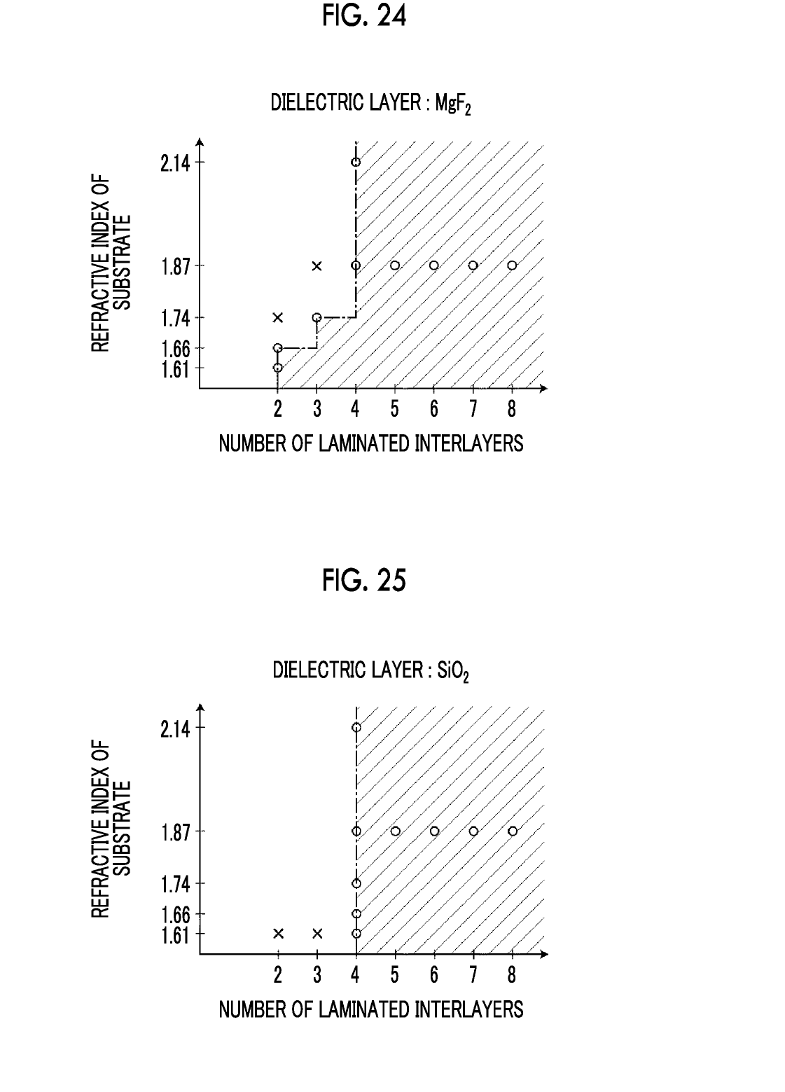

FIG. 24 is a diagram in which Examples and Comparative Examples are mapped in a graph in which the vertical axis represents the refractive index of the substrate and the lateral axis represents the number of laminated interlayers. Among the above examples and comparative examples, an example in which the dielectric layer is formed of MgF₂ and the thickness of the metal layer is 5 nm or less is marked with o and a comparative example in which the dielectric layer is formed of MgF₂ and the thickness of the metal layer is 5 nm or less is marked with x.

As shown in FIG. 24, in a case in which the dielectric layer is formed of MgF₂, the refractive index of the substrate is 1.61 or more and 1.66 or less, and the number of laminated interlayers is 2 or more, an antireflection film having satisfactory antireflection properties can be obtained. In addition, in a case in which the refractive index is 1.61 or more and 1.74 or less and the number of laminated interlayers is 3 or more, an antireflection film having satisfactory antireflection properties can be obtained. Further, in a case in which the number of laminated interlayers is 4 or more, it is found that an antireflection film having satisfactory antireflection properties can be obtained on the substrate having a refractive index of 1.61 or more. That is, in a case in which the dielectric layer is formed of MgF₂ and the thickness of the metal layer is 5 nm or less, it was found that satisfactory antireflection properties could be obtained by forming an antireflection film with a combination of the refractive index of the substrate and the number of laminated interlayers shown in a hatched region in FIG. 24.

FIG. 25 is a diagram in which Examples and Comparative Examples are mapped in a graph in which the vertical axis represents the refractive index of the substrate and the lateral axis represents the number of laminated interlayers. Among the above examples and comparative examples, an example in which the dielectric layer is formed of SiO₂ and the thickness of the metal layer is 5 nm or less is marked with o and a comparative example in which the dielectric layer is formed of MgF₂ and the thickness of the metal layer is 5 nm or less is marked with x.

As shown in FIG. 25, in a case in which the dielectric layer was formed of SiO₂ and the number of laminated interlayers was less than 4, satisfactory antireflection properties could not be obtained even on the substrate having a refractive index of 1.61. In a case in which the number of laminated interlayers was 4 or more, an antireflection film exhibiting satisfactory antireflection properties could be obtained on the substrate having a refractive index of 1.61 or more. That is, in a case in which the dielectric layer is formed of SiO₂ and the thickness of the metal layer is 5 nm or less, it was found that satisfactory antireflection properties could be obtained by forming an antireflection film with a combination of the refractive index of the substrate and the number of laminated interlayers shown in the hatched region in FIG. 25.

[Optical System]

As an example of the optical system of the present invention, the zoom lens having the configuration shown in FIG. 4 which is described in Example 1 of JP2011-186417A was assembled. A ghost generated on the surface of the imaging element was analyzed with the lens data and the reflectance at each surface described in Example 1 of JP2011-186417A by using ray tracing software Zemax, manufactured by LLC. As a result, it was found that, compared to a case in which an antireflection film formed of a dielectric multilayer film and not including a metal layer containing silver is provided to all of the surfaces, in a case in which the antireflection film of Example 1 is provided on the lens L11 of the first lens group G1, which becomes the outermost surface of the group lens, on the left side surface in FIG. 4, and an antireflection film formed of a dielectric multilayer film and not including a metal layer containing silver is provided to optical surfaces than the surface provided with the antireflection film, the ghost level could be suppressed due to a low reflectance.

[Preparation Examples of Metal Film Containing Silver]

From the investigations conducted by the present inventors, it was found that in a case in which the antireflection films having the configurations of Examples and Comparative Examples obtained in the above simulations were actually prepared, antireflection properties significantly varied particularly depending on the accuracy of forming a metal film containing Ag.

### Preparation Example 1

A film formed of pure silver was formed at a thickness of 5 nm on the substrate by an electron beam vapor deposition method using EVD-1501 manufactured by Canon Anelva Corporation and the reflection spectrum of the film formed of pure silver (silver film) was measured by using a reflection film thickness spectrometer FE3000 manufactured by Otsuka Electronics Co., Ltd.

### Preparation Example 2

A silver alloy film was formed was formed at a thickness of 5 nm on the substrate by a sputtering method using GD02 (manufactured by KOBELCO research institute), which is a silver alloy target (Ag-0.7% Nd-0.9% Cu: hereinafter, referred to as ANC), as a target, and the reflection spectrum of the film was measured by using a reflection film thickness spectrometer FE3000 manufactured by Otsuka Electronics Co., Ltd.

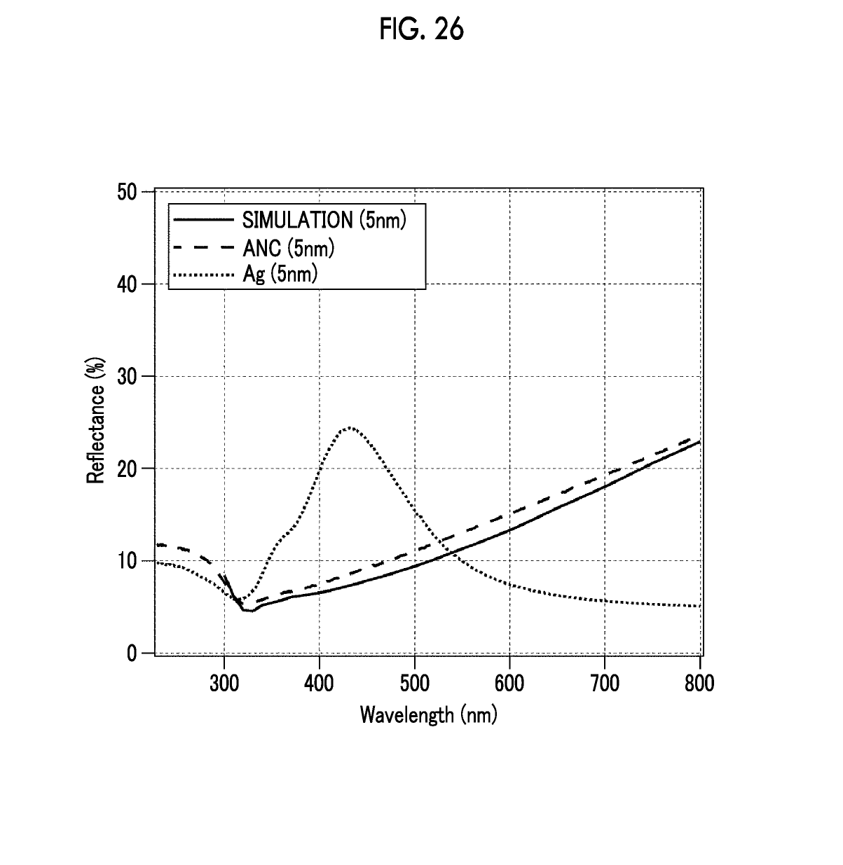

FIG. 26 shows the reflection spectra of the silver film (Ag) of Preparation Example 1 and the silver alloy film (ANC) of Preparation Example 2 together with a calculated value (simulation) of a pure silver film of a thickness of 5 nm.

As shown in FIG. 26, the reflection spectrum of the film of Preparation Example 1 greatly deviated from the calculated value of a pure silver film of a thickness of 5 nm while the reflection spectrum of the film of Preparation Example 2 was consistent with the calculated value with a very high accuracy.

The surface of each film of Preparation Examples 1 and 2 was evaluated using a scanning electron microscope (SEM) and an atomic force microscope (AFM).

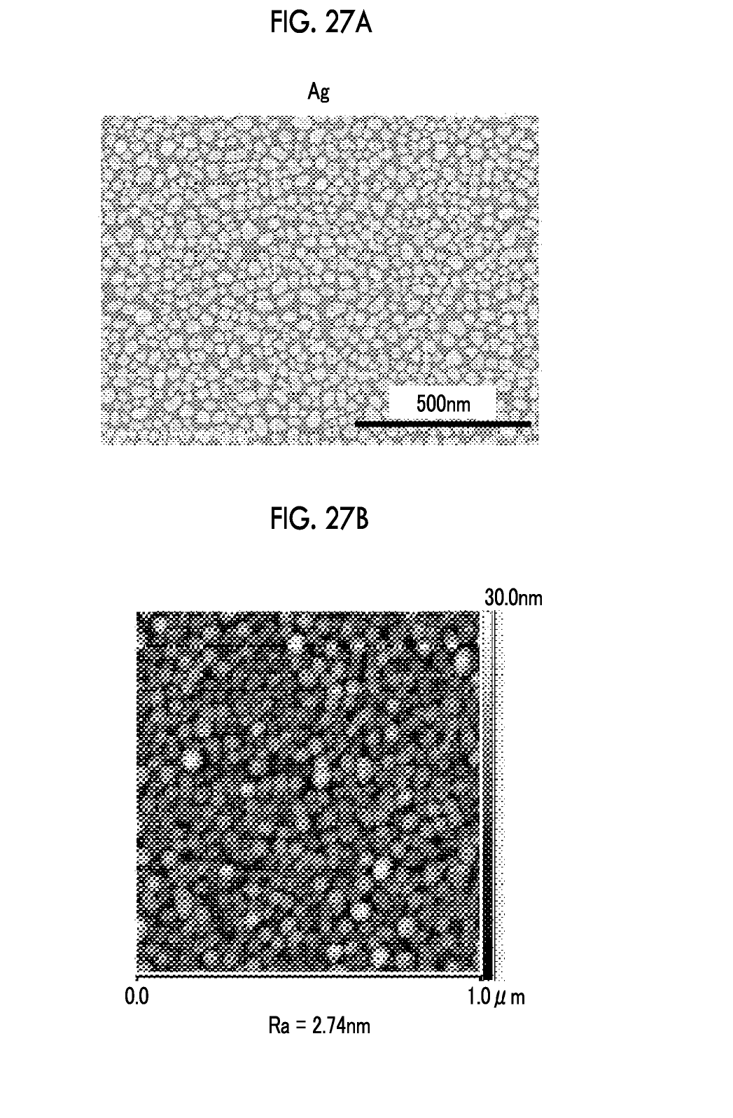

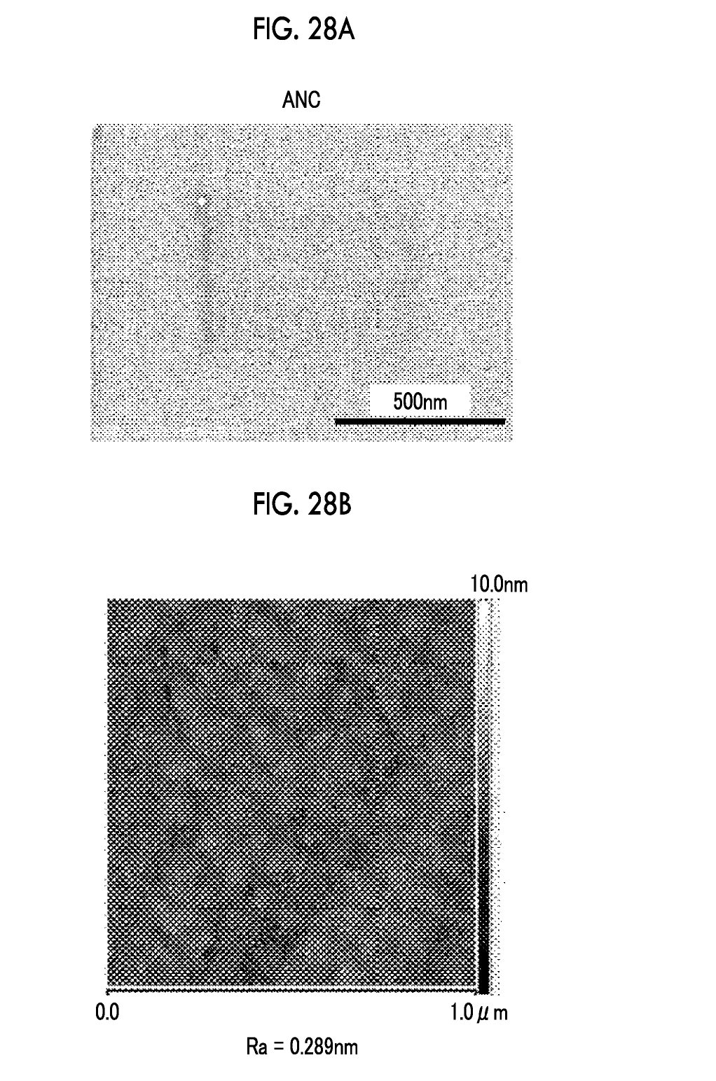

FIGS. 27A and 27B are respectively a SEM image and an AFM image of Preparation Example 1 (Ag) and FIGS. 28A and 28B are respectively a SEM image and an AFM image of Preparation Example 2 (ANC). In FIGS. 27B and 28B, the lateral axis represents a length of 0.0 to 1.0 μm and the vertical axis represents a height with a gray scale. In FIG. 27B, a deep black color indicates a height of 0 nm and a pure white color indicates a height of 30 nm, and in FIG. 28B, a deep black color indicates a height of 0 nm and a pure white color indicates a height of 10 nm.

As shown in FIGS. 27A and 27B, it was found that the Ag film of Preparation Example 1 was not formed to have a uniform film thickness, grew into a granular form, and had a surface roughness Ra of 2.74 nm. It is considered that since silver grows in a granular form as described above, plasmon resonance caused by incidence ray and thus the reflection spectrum in which the reflectance is greatly different from the calculated value is obtained. On the other hand, as shown in FIGS. 28A and 28B, the ANC alloy film has a small surface roughness Ra of 0.289 nm and thus a film having high flatness is obtained.

The simulation in FIG. 26 is about the wavelength dependence of the reflectance in a case of using silver for a metal layer. However, it is considered that as the surface roughness becomes smaller and the flatness becomes higher as in the sputtered film formed using the silver alloy target of Preparation Example 2 as a metal layer, an antireflection film having properties closer to the wavelength dependence of the reflectance obtained in the simulation is more likely to be obtained.

Further, an investigation to obtain a film having high flatness as the metal layer containing silver was conducted.

### Preparation Example 3

A silver alloy film was formed at a thickness of 5 nm on the substrate by a sputtering method using GBD05 (manufactured by KOBELCO research institute), which is a silver alloy target (Ag-0.35% Bi-0.2% Nd), as a target, to form a film of Preparation Example 3. The same evaluation was carried out as in Preparation Examples 1 and 2. The reflectance of the film of Preparation Example 3 was consistent with the calculated value with a very high accuracy. In addition, a film having a surface roughness Ra of 0.237 nm and a high flatness was obtained.

### Preparation Example 4

A silver alloy film was formed at a thickness of 5 nm on the substrate by a sputtering method using APC (manufactured by FURUYA METAL Co., Ltd.), which is a silver alloy target (Ag—Pd—Nd), as a target to form a film of Preparation Example 4. The film prepared was evaluated in the same manner as in Preparation Examples 1 and 2. The reflectance of the film of Preparation Example 4 was consistent with the calculated value with a very high accuracy. In addition, a film having a surface roughness Ra of 0.457 nm and a high flatness was obtained.

In Preparation Examples 3 and 4, as in Preparation Example 2, the wavelength dependence of the reflectance closer to the calculated value could be obtained compared to the film formed using pure silver, and the surface roughness was small. Particularly, in a case of using the silver alloy target formed of Ag—Bi—Nd of Preparation Example 3, higher flatness was obtained.

### Preparation Example 5

A germanium film, as an anchor layer, was formed at a thickness of 0.5 nm on the substrate by an electron beam vapor deposition method using EVD-1501 manufactured by Canon Anelva Corporation. A film formed of pure silver was formed on the vapor-deposited germanium film at a thickness of 5 nm by a sputtering method to prepare a film of Preparation Example 5. The prepared film was evaluated in the same manner as in Preparation Examples 1 and 2. The reflectance of the film of Preparation Example 5 was consistent with the calculated value with a very high accuracy. In addition, a film having a surface roughness Ra of 0.421 nm and a high flatness was obtained.

### Preparation Example 6

A titanium film, as an anchor layer, was formed at a thickness of 0.5 nm on the substrate by a sputtering method. A film formed of pure silver was formed on the formed titanium germanium film at a thickness of 5 nm by a sputtering method to prepare a film of Preparation Example 6. The prepared film was evaluated in the same manner as in Preparation Examples 1 and 2. The reflectance of the film of Preparation Example 6 was consistent with the calculated value with a very high accuracy. In addition, a film having a surface roughness Ra of 0.442 nm and a high flatness was obtained.

### Preparation Example 7

A germanium film, as an anchor layer, was formed on the substrate at a thickness of 0.5 nm by a sputtering method. A silver alloy film was formed on the formed germanium film at a thickness of 5 nm by a sputtering method using GD02 (manufactured by KOBELCO research institute), which is a silver alloy target (Ag-0.7% Nd-0.9% Cu), as a target, to prepare a film of Preparation Example 7. The prepared film was evaluated in the same manner as in Preparation Examples 1 to 2. The reflectance of the film of Preparation Example 7 was consistent with the calculated value with a very high accuracy. In addition, a film having a surface roughness Ra of 0.225 nm and a high flatness was obtained.

As in Preparation Examples 5 to 7, a film having high flatness could be obtained by providing the anchor layer below the pure silver film or the silver alloy film, compared to a case of not providing the anchor layer. Accordingly, it is considered that an antireflection film having properties closer to the wavelength dependence of the reflectance obtained in the simulation can be obtained by providing the anchor layer.

### EXPLANATION OF REFERENCES

1, 21, 31: antireflection film
2, 22, 32: substrate
3, 23, 33: interlayer
4: metal layer
5, 25: dielectric layer
6: anchor layer
10, 20, 30: optical element
11: layer of high refractive index
12: layer of low refractive index

What is claimed is:

1. An antireflection film comprising:
a dielectric layer having a surface exposed to air and having a refractive index of 1.35 or more and 1.51 or less;
a metal layer having an interface with the dielectric layer, containing silver (Ag), and having a thickness of 2 nm or more and 5 nm or less; and
an interlayer having an interface with the metal layer and constituted by a laminate formed by alternately laminating total four layers or more of a layer of high refractive index having a relatively high refractive index and a layer of low refractive index having a relatively low refractive index,
wherein the antireflection film is laminated on a substrate having a refractive index of 1.61 or more in the order of the interlayer, the metal layer, and the dielectric layer.

2. The antireflection film according to claim 1,
wherein the dielectric layer is formed of silicon oxide or magnesium fluoride.

3. An antireflection film comprising:
a dielectric layer having a surface exposed to air and formed of magnesium fluoride;
a metal layer having an interface with the dielectric layer, containing silver (Ag), and having a thickness of 2 nm or more and 5 nm or less; and
an interlayer having an interface with the metal layer and constituted by a laminate formed by alternately laminating total three layers or more of a layer of high refractive index having a relatively high refractive index and a layer of low refractive index having a relatively low refractive index,
wherein the antireflection film is laminated on a substrate having a refractive index of 1.61 or more and 1.74 or less in the order of the interlayer, the metal layer, and the dielectric layer.

4. An antireflection film comprising:
a dielectric layer having a surface exposed to air and formed of magnesium fluoride;
a metal layer having an interface with the dielectric layer, containing silver (Ag), and having a thickness of 2 nm or more and 5 nm or less; and
an interlayer having an interface with the metal layer and constituted by a laminate formed by alternately laminating total two layers or more of a layer of high refractive index having a relatively high refractive index and a layer of low refractive index having a relatively low refractive index,
wherein the antireflection film is laminated on a substrate having a refractive index of 1.61 or more and 1.66 or less in the order of the interlayer, the metal layer, and the dielectric layer.

5. The antireflection film according to claim 1,
where in the layer of high refractive index is a layer having a higher refractive index than the refractive index of the substrate, and
the layer of low refractive index is a layer having a lower refractive index than the refractive index of the substrate.

6. The antireflection film according to claim 3,
where in the layer of high refractive index is a layer having a higher refractive index than the refractive index of the substrate, and
the layer of low refractive index is a layer having a lower refractive index than the refractive index of the substrate.

7. The antireflection film according to claim 4,
where in the layer of high refractive index is a layer having a higher refractive index than the refractive index of the substrate, and
the layer of low refractive index is a layer having a lower refractive index than the refractive index of the substrate.

8. The antireflection film according to claim 1,
wherein the laminate constituting the interlayer has 16 layers or less.

9. The antireflection film according to claim 3,
wherein the laminate constituting the interlayer has 16 layers or less.

10. The antireflection film according to claim 4,
wherein the laminate constituting the interlayer has 16 layers or less.

11. The antireflection film according to claim 1,
wherein the metal layer is formed of a silver alloy containing at least one metal element in addition to silver.

12. The antireflection film according to claim 3,
wherein the metal layer is formed of a silver alloy containing at least one metal element in addition to silver.

13. The antireflection film according to claim 4,
wherein the metal layer is formed of a silver alloy containing at least one metal element in addition to silver.

14. The antireflection film according to claim 1,
wherein an anchor layer formed of a metal element other than silver is provided between the metal layer and the interlayer.

15. The antireflection film according to claim 3,
wherein an anchor layer formed of a metal element other than silver is provided between the metal layer and the interlayer.

16. The antireflection film according to claim 4,
wherein an anchor layer formed of a metal element other than silver is provided between the metal layer and the interlayer.

17. An optical element comprising:
a substrate; and
the antireflection film according to claim 1 arranged on the substrate.

18. An optical element comprising:
a substrate; and
the antireflection film according to claim 3 arranged on the substrate.

19. An optical element comprising:
a substrate; and
the antireflection film according to claim 4 arranged on the substrate.

20. An optical system comprising:
a group lens formed by arranging the antireflection film of the optical element according to claim 17 on outermost surfaces thereof.

21. An optical system comprising:
a group lens formed by arranging the antireflection film of the optical element according to claim 18 on outermost surfaces thereof.

22. An optical system comprising:
a group lens formed by arranging the antireflection film of the optical element according to claim 19 on outermost surfaces thereof.
